(19) United States
(12) Patent Application Publication
(10) Pub. No.: US 2009/0222798 A1
(43) Pub. Date: Sep. 3, 2009

(54) Information Processing Apparatus

(76) Inventors: Shinya IGUCHI, Yokohama (JP); Takatoshi Kato, Yokohama (JP); Masaya Umemura, Yokosuka (JP); Nobuaki Kohinata, Yokohama (JP); Yasushi Nagai, Yokohama (JP); Hiroshi Nakagoe, Yokohama (JP); Keitaro Okasaki, Yokohama (JP); Hirotaka Moribe, Yokohama (JP); Takeshi Asahi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/332,397

(22) Filed: Dec. 11, 2008

(30) Foreign Application Priority Data
Feb. 29, 2008 (JP) 2008-051271

(51) Int. Cl. G06F 9/45

(52) U.S. Cl. 717/137; 717/137; 717/148

(57) ABSTRACT

A mobile device includes a memory for storing therein a subroutine management table to manage kinds of existing codes out of native code, first code and second code for a plurality of subroutines contained in content, a virtual machine, a precompile circuit for producing second code from first code and a subroutine management circuit for changing over processing in accordance with the kind of existing code for subroutine called up during execution of content. The subroutine management circuit judges kind of existing code with reference to the subroutine management table when the processing is changed over.

### INCORPORATION BY REFERENCE

The present application claims priority from Japanese application JP-2008-051271 filed on Feb. 29, 2008, the content of which is hereby incorporated by reference into this application.

### BACKGROUND OF THE INVENTION

The present invention relates a virtual machine including JIT (Just-In-Time) compiler which operates in an information processing apparatus such as mobile device, car navigation device and television receiver.

Recently, the contents demanded by users are often provided in a homepage as downloadable applications or as Web applications usable as they are. These contents contain not only computer programs such as document editing software, table calculation software and mail transmission/reception software but also software such as game, novel, moving picture and animation.

However, since the application and the browser for displaying it are mainly prepared for the purpose of perusal or reading, they are inferior to desk-top application such as Windows (R) in picture design, operation and response. Accordingly, in order to improve these problems, the technique such as JavaScript (R Refer to “Introduction to JavaScript”, Refsnes Data, <URL: http://www.w3schools.com/js/js#intro.asp>) and Ajax (refer to “Ajax (programming)”, Feb. 6, 2008, Wikipedia, <URL: http://en.wikipedia.org/wiki/AJAX>) is used to develop Web application named Rich Internet Application (refer to RIA, “Rich Internet Application”, Feb. 3, 2008, Wikipedia, <URL: http://en.wikipedia.org/wiki/Rich#Internet#application>) having the performance similar to the existing desk-top application.

The application execution environment named the media player which can display advanced animation and moving picture is developed as a plug-in unit of the browser or a simple application. Even by using this media player, an application execution environment similar to an existing desk-top application can be realized.

The browser and the media player are widely used even in apparatuses except personal computers (PC), so-called built-in apparatuses each including a central processing unit (CPU) and controlled by software to be operated. The built-in apparatuses contain, for example, personal devices such as mobile devices, other portable information devices, car navigation devices, home telephones, portable game machines, home game machines and HDD (Hard Disk Drive) recorders and business apparatuses such as karaoke apparatuses, robots, transport apparatuses for railroad, rockets and plant controllers.

The browser and the media player use the standard technique such as HTML, XML, Java™ and JavaScript™ and accordingly it is not necessary to feel difference in architecture as in operating system (OS) when a content is prepared. Accordingly, a once developed content can be operated without changing it in any terminal in principle, so that drastic reduction of development cost and improvement of compatibility can be realized.

When the content is developed for built-in apparatuses, it must be considered that resources are limited strictly in the aspects of processing speed of CPU, memory capacity, picture display ability and the like as compared with personal computers differently from content for personal computers. Specifically, in development of RIA (Rich Internet Application), operation is often described in Java or script language such as JavaScript. However, the script language has description amount reduced as compared with C++ and accordingly it is advantageous that the development efficiency is good whereas there is a problem that the execution speed in the same environment is as slow as five times and more. The problem that the execution speed is slow is common to the program described in Java (Java program) or script languages.

As a cause of the problem, it is considered that Java program and program containing codes described in script language are distributed in the format different from native code capable of being directly executed by operating system of information processing apparatus such as built-in apparatus. The Java program is once compiled into intermediate code named Java byte code of binary format which does not depend on architecture of operating system and hardware and then distributed in the intermediate code state.

In other words, the program of intermediate code format is executed by the interpreter system or the Just-In-Time compile (JIT compile) system. Concretely, in the case of the interpreter system, for example, the program is executed while the interpreter constituted by software converts intermediate code into native code successively (for example, conversion is made in code unit). In the case of the JIT compile system, for example, the program is executed after the JIT compile constituted by software once converts intermediate code into native code (for example, conversion is made in subroutine unit). More particularly, the native code produced even by any of the interpreter system and the JIT compile system is executed by a central processing unit (CPU) actually. A lot of information processing apparatuses such as personal computers are provided with a virtual machine having the interpreter and the JIT compiler. In the case of the JavaScript, there are a lot of cases where a script engine including the browser interprets the script and the program is executed in the interpreter form. In any cases, as compared with the program distributed in the state that the program has been compiled into native code, the time required to complete processing is long when the program is executed in the interpreter form and the overhead required to complete the compile occurs when the program is executed by the JIT compile, so that the execution speed is slow.

Hereafter, when development of the content using Java™ and script language is increased on a large scale, it is important to solve this problem. Examples in the prior art to solve this problem are described below:

### (1) Improvement of Operation Speed of Processor

It is considered that if the operation speed of the processor is increased, the operation speed of the JIT compiler and the interpreter constituted by software can be increased and the execution processing of content can be performed at high speed.

### (2) Improvement of Execution Speed by Interpreter

It is considered that if the operation speed of the interpreter itself is increased, the overhead until start of script processing is also eliminated and the execution processing can be performed at high speed. For example, “Java processor”, Jan. 22, 2008, Wikipedia, <URL: http://en.wikipedia.org/wiki/java#processor>discloses a product in which the interpreter is formed by hardware to constitute a dedicated processor so that high-speed performance is attained.

### (3) Technique That Useless Compile is Not Performed

U.S. Pat. No. 6,996,814 B2 discloses the technique that only the method requiring compile is compiled and useless compile is not performed. Concretely, in this technique, the method being executed by the interpreter is detected and the execution by the interpreter is interrupted or the multi-threading is utilized to compile byte code executed by the interpreter into native code. When the compile is ended, the byte code is used from the interrupted point of the processing by the interpreter to resume the execution or the produced native code is used to perform the processing.

### (4) Technique of Judging Whether Compile is Required or Not at High Speed

JP-A-2006-202317 discloses the technique of performing processing at high speed by judging whether compile is performed or not and facilitating retrieval of storage address of native code when byte code and native code are mixed in memory. Concretely, information for judging whether byte code is compiled or not and a retrieval table for retrieving address of compiled native code are stored in memory and this retrieval table is retrieved upon execution of byte code, so that judgment as to whether compile is required or not and retrieval of storage address of native code can be performed easily (at high speed).

### SUMMARY OF THE INVENTION

However, the techniques described in the above items (1) and (2) have a problem that application to a built-in apparatus is difficult since power consumption and cost thereof are increased.

In the technique described in the above item (3), when the processing by the interpreter is interrupted to perform compile, the time required until the interpreter is interrupted and the time required for the compile become overhead, so that the execution time is increased (execution speed is reduced). On the other hand, when the compile is performed while the processing by the interpreter is performed, the multi-thread processing is performed and accordingly there is a problem that the execution speed by the interpreter is reduced.

The technique described in the above item (4) has a problem that overhead upon JIT compile is not solved and access to memory by CPU frequently occurs upon retrieval of the retrieval table, so that the execution speed is reduced.

The present invention provides technique that is suitable for application to a built-in apparatus and realizes improvement of execution speed of content and low power consumption.

The information processing apparatus of disclosed system comprises a memory to store therein a subroutine management table which manages kinds of existing codes out of a native code executable by a processor, a first code which is a source of the native code and does not depend on an operating system and a second code produced in process of converting the first code into the native code for a plurality of subroutine contained in a content, a virtual machine having an interpreter function to execute the first code by an interpreter method and a JIT (Just-In-Time) compile function to convert the second code into the native code to be executed, a precompile circuit to produce the second code from the first code and subroutine management means to perform execution control so that as a result of referring to the subroutine management table for the subroutine called up during execution of the content, when there is the native code, the native code is executed by the processor and when there is the second code, the second code is executed by the JIT compile function of the virtual machine and the produced native code is stored in the memory or when there is the first code, the first code is executed by the interpreter function of the virtual machine and is converted into the second code by the precompile circuit to store the second code in the memory, the subroutine management means performing recording control so that when the kind of code referred to when the subroutine is executed by the execution control is changed, the changed kind is recorded in the subroutine management table.

The subroutine management means may perform the execution control so that the first code is converted into the second code in order from subroutine having higher priority for conversion of the first code into the second code and defined on the basis of a predetermined standard for each subroutine.

The memory stores therein an operation speed definition table in which operation speed of the precompile circuit is defined in accordance with the priority and further the information processing apparatus may comprise precompile control means which controls to judge the operation speed from the operation speed definition table on the basis of the priority of the subroutine corresponding to the first code processed by the precompile circuit and operate the precompile circuit in accordance with the operation speed.

The number of times of called operations of each subroutine called up during execution of the content or a value obtained by subtracting the number of stack frames at the time that each subroutine is called up during execution of the content from a predetermined value may be adopted as the priority. Alternatively, a value previously described in the first code of each subroutine on the basis of time required to convert the first code of each subroutine contained in the content into the second code or frequency with which each subroutine is called up during execution of the content may be adopted as the priority.

The precompile control means of the disclosed system may be configured to reduce a supply voltage to the precompile circuit within a range of voltage by which operation of the precompile circuit can be maintained when the operation speed of the precompile circuit is reduced.

The precompile control means may be configured to monitor a data transmission amount within a bus or access frequency to the memory by the processor and stop operation of the precompile circuit while the data transmission amount or the access frequency exceeds a predetermined reference.

The information processing apparatus further comprises a cache memory in which contents of the subroutine management table are stored as a subroutine management table cache and the subroutine management means may perform the execution control and the recording control on the basis of the subroutine management table cache instead of the subroutine management table and may perform cache control so that transfer and rewriting of data are performed between the subroutine management table and the subroutine management table cache at predetermined timing.

The subroutine management means may perform the cache control so that when the content is started to be executed, information of the subroutine contained in the content to be executed is written from the subroutine management table into the subroutine management table cache in order of higher priority and when information of the called-up subroutine does not exist in the subroutine management table cache during execution of the content, information of the subroutine having lowest priority in the subroutine management table cache is written back into the subroutine management table and information of the called-up subroutine is written from the subroutine management table into the subroutine management table cache.

The first code may be a code for stack machine and the second code may contain a code for register machine produced from the first code.

The second code may contain a code formed by inline expanding the first code of another subroutine called up in execution process of the subroutine into a first code of the subroutine of a calling source.

The memory may store therein a correction dictionary in which a correction method of unnecessary description, grammatical defect or error in writing in the first code is defined and the second code may contain a code formed by optimizing the first code on the basis of the correction dictionary.

The JIT compile function of the disclosed system may be configured to inline expand the second code of precompile result of the first code of another subroutine called up in execution process of the second code into the second code of a calling source and convert it into the native code.

The memory may be configured to store therein a subroutine sharing table representing correspondence relation to a plurality of contents for each subroutine and the subroutine management means may be configured to perform the execution control so that the first code is converted into the second code in order from subroutine having corresponding contents increased in number on the basis of the subroutine sharing table instead of the priority.

The subroutine management means may perform the execution control so that the first code is converted into the second code in order from subroutine called up finally of subroutines called up during execution of the content instead of the priority.

The first code may include attribute information described previously therein for representing contents of processing for corresponding subroutine and the memory may store therein an attribute management table in which priority order for producing the second code from the first code for each attribute information is defined. The subroutine management means may be configured to perform the execution control so that the priority order is specified from the attribute management table by means of attribute information described in the first code of subroutine called up during execution of the content and the first code is converted into the second code in accordance with the priority order instead of the priority.

Furthermore, the information processing apparatus may comprise a display to display an indication corresponding to the content and the subroutine management means may be configured to perform the execution control so that the second code is produced preferentially from the first code of subroutine contained in the content corresponding to the indication displayed in center or in front of the display or a largest indication displayed on the display instead of the priority. In this case, the information processing apparatus may further comprise an operation part to move an indicator containing arrow displayed on the display and select the indication by the indicator and the subroutine management means may be configured to perform the execution control so that the second code is produced preferentially from the first code of subroutine contained in the content corresponding to the indication overlapping the indicator or the indication selected by the indicator on the display.

Part or all of the contents treated as an execution object in the disclosed system may be script or Java program.

According to the teaching herein, the compile into native code can be performed at high speed to thereby realize remarkable improvement of execution speed of content and low power consumption.

Other objects, features and advantages of the invention will become apparent from the following description of the embodiments of the invention taken in conjunction with accompanying drawings.

### BRIEF DESCRIPTION OF THE DRAWINGS

FIG. 1 is a block diagram schematically illustrating basic configuration of a mobile device to which the present invention is applied;

FIG. 2 shows content management table, subroutine management table and subroutine management table cache;

FIG. 3 shows operation speed definition table for defining operation speed of precompile circuit;

FIG. 4 schematically illustrates configuration of memory, non-volatile recording medium and cache memory upon execution of content and basic operation of hardware utilizing them;

FIG. 5 is a flow chart showing processing of subroutine management circuit upon start of execution of content;

FIG. 6 is a flow chart showing subroutine management table retrieval and execution processing by processor and subroutine management circuit;

FIG. 7 is a flow chart showing operation of first code processing unit upon precompile;

FIG. 8 is a flow chart showing processing performed by precompile circuit 173 during period from beginning to end of precompile;

FIG. 9 is a flow chart showing operation speed control of precompile circuit by precompile control circuit;

FIG. 10 is a flow chart showing update processing of subroutine management table cache by subroutine management circuit;

FIG. 11 is a sequential chart showing basic operation of mobile device;

FIG. 12 is a flow chart showing content ending processing performed by subroutine management circuit;

FIG. 13 schematically illustrates configuration of mobile device and content delivering server and cooperation method thereof; and

FIG. 14 is a flow chart showing content registration processing by subroutine management part.

### DETAILED DESCRIPTION OF THE EMBODIMENTS

In embodiments of the present invention, a method of executing Java program as content containing a plurality of subroutines in a mobile device is now described. In this explanation, functions which are usually included in a mobile device such as voice communication function, mail transmission/reception function, schedule management function and imaging function are omitted from drawings and description. Moreover, in the object-oriented programming, generally, programs corresponding to subroutines are sometimes named methods, although in the embodiment any of them is named subroutine irrespective of the orientation of programming.

### Embodiment 1

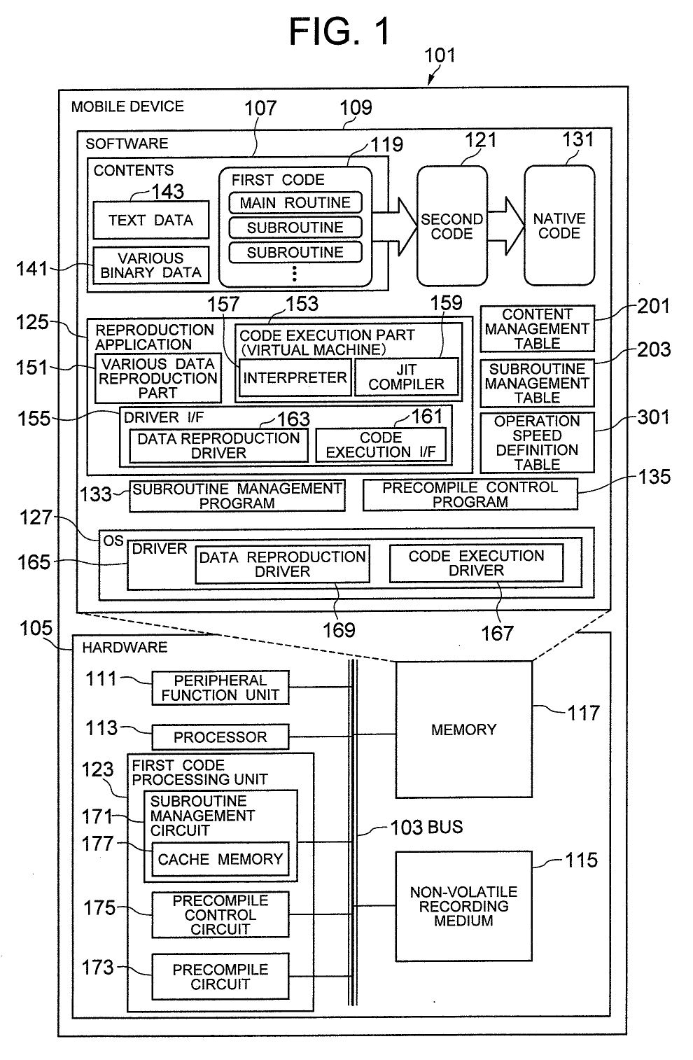

FIG. 1 is a basic block diagram schematically illustrating a mobile device 101 to which the present invention is applied.

The mobile device 101 includes a variety of hardware 105 coupled through a bus 103 with each other and a variety of software 109 containing programs for controlling the hardware and a plurality of contents 107 executed in the mobile device 101.

More particularly, the mobile device 101 includes a peripheral function unit 111 having the function of reception of user's operation, display of picture, communication and input/output, a processor 113 for executing various programs such as reproduction application 125 contained in the software 109, a non-volatile recording medium 115 for recording therein data of part or all of the software 109 even during cutting off of power of the mobile device 101, a memory 117 for storing therein data concerning the software 109 being executed and a first code processing unit 123 for converting Java byte code (hereinafter referred to as “first code”) 119 constituting Java program and which is a source of native code executable by the processor 113 and does not depend on operating system (OS) into code (hereinafter referred to as “second code”) 121 produced in the process of conversion into native code.

The peripheral function unit 111 can adopt, for example, operation buttons, touch panel, display, microphone, loudspeakers and network coupling unit.

The non-volatile recording medium 115 can adopt a recording medium such as, for example, flash memory, hard disk drive (HDD), Magnetoresistive Random Access Memory (MRAM) and Ferroelectronic Random Access Memory (FeRAM). The memory 117 can adopt a recording medium such as Static Random Access Memory (SRAM), Dynamic Random Access Memory (DRAM) and MRAM. These hardware is desirably selected in consideration of conditions such as cost, memory capacity, power consumption and reading/writing speed at manufacturing time.

The mobile device 101 includes software 109 containing program for controlling the hardware 105 and Java program executed in the mobile device 101 and which is stored in the memory 117. More particularly, the software 109 includes content 107 (containing first code 119 described later) such as Java program, reproduction application 125, operating system (OS) 127 and, as three kinds of tables referred to properly upon execution of content 107, content management table 201, subroutine management table 203 and operation speed definition table 301.

In addition, the software 109 includes second code 121 produced by processing of first code processing unit 123 and native code 131 produced by processing of virtual machine 129 described later. Moreover, the software 109 includes subroutine management program 133 having combination of various instructions such as processing instruction conforming to kind of codes (first code 119, second code 121 and native code 131) of subroutine and update instruction of table such as subroutine management table 203 and precompile control program 135 having combination of various instructions such as control instruction of precompile circuit 173 described later for producing second code 121 from first code 119.

The processor 113 executes subroutine management program 133 to control subroutine management circuit 171 described later and constitutes subroutine management part together with the subroutine management circuit 171. Furthermore, the processor 113 executes precompile control program 135 to control precompile control circuit 175 and constitutes subroutine control part together with precompile control circuit 175. The contents 107 are constituted by, for example, first code 119, various binary data 141 and text data 143 as program and data required to execute Java program. Various applications such as game, moving picture, animation, document editing software and table calculation software can be adopted as kind of contents 107 irrespective of high and low levels of function.

The first code 119 is program code having the format which does not depend on architecture (e.g. OS) of the mobile device 101 which executes content 107 and is constituted by a plurality of subroutines. The subroutine described in the embodiment contains main routine. The first code 119 of Java program is not compiled into the format (native code 131) executable by the processor 113 of the mobile device 101 but is compiled into the format which does not depend on architecture. Accordingly, the first code 119 is required to be compiled into the format corresponding to the processor 113 of the mobile device 101 upon execution again.

The various binary data 141 can contain moving picture, still picture, voice, vector, 3D painting data, various setting data and character string. Text data 143 is data of character string type and can express various data in the state that text data is built in directly by using language such as, for example, XML (Extensible Markup Language).

The reproduction application 125 is program such as browser for executing the content 107 and various media players. The reproduction application 125 includes various data reproduction part 151 for reproducing data such as moving picture, voice and still picture contained in content 107, a code execution part (virtual machine) 153 for executing first code 119 and second code 121 and a driver interface (I/F) 155 utilized when the above functions access to operating system 127 and hardware 105.

The code execution part (virtual machine) 153 includes an interpreter 157 and JIT compiler 159 and starts any of them in response to condition described later and accesses to first code processing unit 123 if necessary.

The interpreter is a program for successively executing in code unit, for example, the processing for analyzing first code 119 of subroutine called up during execution of the content 107 and converting it into native code 131 while making the processor 113 execute the native code 131 successively.

The JIT compiler 159 is a program for executing in subroutine unit or loop processing unit, for example, the processing for once converting the second code of subroutine called up during execution of the content 107 into native code and then making CPU execute the native code 131.

The driver I/F 155 includes a code execution interface (I/F) 161 and a data reproduction interface (I/F) 163. The code execution I/F 161 is utilized to access to the first code processing unit 123 of the hardware 105. The data reproduction I/F 163 is utilized to access to various hardware 105 when the various data reproduction part 151 reproduces content data.

The operating system 127 is basic software for a built-in apparatus such as the mobile device 101. As examples of the operating system 127, there is considered software such as Linux, WindowsEmbedded and Symbian. Moreover, the operating system 127 includes a driver 165 required to make the reproduction application 125 access to the hardware 105.

The driver 165 includes a code execution driver 167 and a data reproduction driver 169. The code execution driver 167 provides function for making the reproduction application 125 access to the hardware 105 upon execution of the content 107. The data reproduction driver 169 provides function for making the reproduction application 125 access to the hardware 105 upon data processing except execution of the content 107.

The interpreter 157 and the JIT compiler 159 of the code execution part 153 can access to the code execution driver 167 through code execution I/F 161 if necessary to call up various hardware 105. At this time, when there is no necessary hardware 105, software emulator can be started to realize necessary function. Accordingly, when function of other hardware which cannot be realized by hardware 105 is required, it is desirable that software emulator is provided as software 109.

The content management table 201 manages IDs and names of the contents 107. The subroutine management table 203 manages information containing kinds of existing codes out of first code 119, second code 121 and native code 131, number of times of called operations (references) and memory address (top address) representative of execution start position for each of subroutines constituting the content 107. The operation speed definition table 301 defines control method of processing by the first code processing unit 123. These tables are described in detail later.

The first code processing unit 123 includes a subroutine management circuit 171 constituting a subroutine management part which performs control under control of the processor 113 which executes the subroutine management program 133 so that information containing kinds of existing codes out of first code, second code and native code, number of times of called operations, top address for each of subroutines constituting the content 107 is cached from subroutine management table 203 to be managed and processing is executed in accordance with the kind of code of the subroutine, a precompile circuit 173 which converts first code 119 into second code 121, and a precompile control circuit 175 constituting a precompile control part which controls operation of the precompile circuit 173 under control of the processor 113 which executes the precompile control program 135.

The subroutine management circuit 171 includes a cache memory (e.g. associative memory) 177 for storing therein the above information and functioning as a memory for retrieving contents thereof at high speed. In the embodiment, the above information stored in the cache memory 177 is named subroutine management table cache. Rewriting or replacement of contents is performed between the subroutine management table and the subroutine management table cache at predetermined timing. Consequently, part or all of information of the subroutine management table 203 stored in the memory 117 is stored in the subroutine management table cache as a minimum. The contents of the subroutine management table cache are described later.

Further, the subroutine management circuit 171 subjects the subroutine called up during execution of the contents 107 to the following control in accordance with the result of referring to the subroutine management table cache 205.
(1) When there is native code 131, execution control is performed so that the native code 131 is executed by the processor 113. Concretely, in the embodiment 1, the top address of native code 131 of the called-up subroutine is returned to the processor 113.
(2) When there is second code 121, execution control is performed so that the second code 121 is executed by JIT compiler 159 of virtual machine 153 and the produced native code 131 is stored in the memory 117. Concretely, in the embodiment 1, the kind (second code 121) of code of the called-up subroutine is notified to the processor 113. Thus, the processor 113 operates JIT compiler 159 and stores the produced native code 131 into the memory 117. Further, the subroutine management circuit 171 may control to store the native code into the memory 117.
(3) When there is first code 119, execution control is performed so that the first code 119 is executed by interpreter 157 of virtual machine 153 and converted into second code 121 by the precompile circuit 173 to store the second code 121 into the memory 117. Concretely, in the embodiment 1, the kind (first code 119) of code of the called-up subroutine is notified to the processor 113. Consequently, the processor 113 operates the interpreter 157. Moreover, the subroutine management circuit 171 makes the precompile control circuit 175 control the precompile circuit 173 so that the precompile circuit 173 produces second code 121 from first code 119 of the called-up subroutine. The produced second code 121 is stored in the memory 117 by any of subroutine management circuit 171, precompile control circuit 175 and precompile circuit 173.

Moreover, when kind of code to be executed upon execution of subroutine is changed (first code 119 is changed to second code 121 and second code 121 is changed to native code 131) in accordance with the control of the above items (2) or (3), recording control is performed so that the changed kind is recorded in the subroutine management table cache 205. Concretely, in the embodiment 1, the subroutine management circuit 171 rewrites the subroutine management table cache 205.

The precompile circuit 173 functions so as to get second code 121 produced when first code 119 is compiled into native code 131. The second code 121 produced by precompile of the precompile circuit 173 contains, for example, as follows:
(1) Code for register machine produced from first code 119 for stack machine,
(2) Code gotten by inline expanding the first code 119 of another subroutine called up in execution process of subroutine into the first code 119 of the subroutine of calling source, and
(3) Code gotten by optimizing the first code on the basis of a correction dictionary stored in the memory 117 and in which a correction method of unnecessary description, grammatical defect or error in writing in the first code 119 is defined.

However, even except the above method, it is a matter of course that a prior-art precompile method is applied to precompile by the precompile circuit 173.

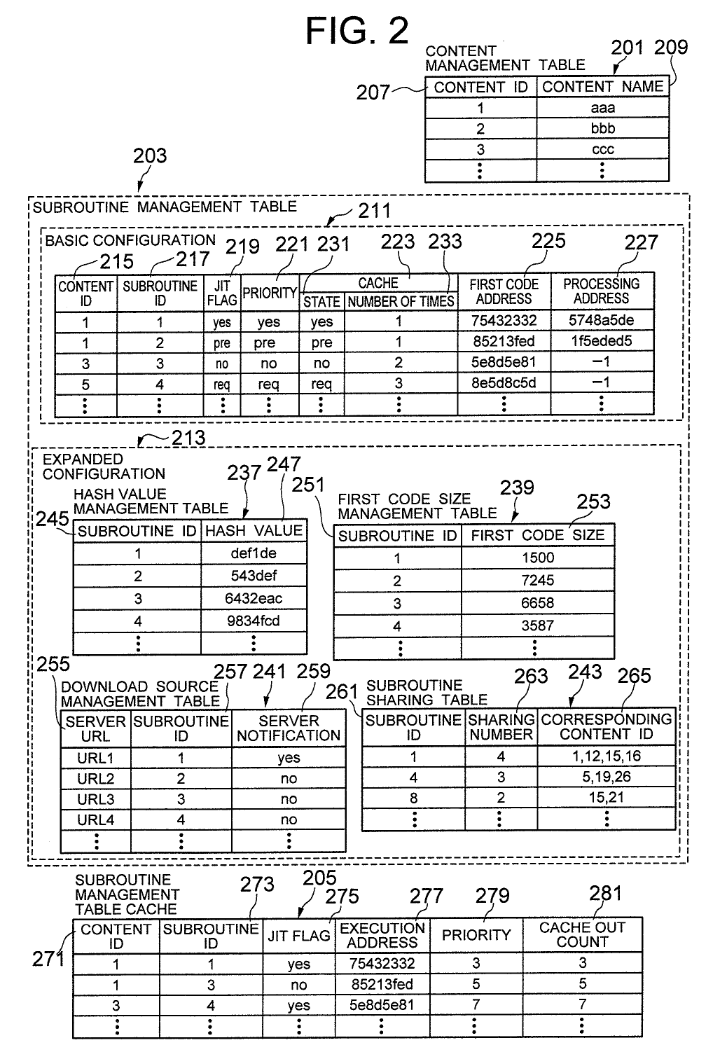

FIG. 2 shows the content management table 201 and the subroutine management table 203 stored in the memory 117 and the subroutine management table cache 205 stored in the cache memory 177. The contents of these tables are now described.

The content management table 201 includes various items containing content ID column 207 and content name column 209. Content IDs for identifying content 107 stored in the mobile device 101 are stored in the content ID column 207. Names of contents are stored in the content name column 209. The content management table 201 is used to manage IDs and names of contents.

As the method of assigning content IDs, there are, for example, a method of making a service provider uniquely assign IDs common to various services such as content downloading service available in the mobile device 101 and a method of assigning IDs used only in the mobile device 101 originally by the mobile device 101 or the service provider. In the latter case, for example, there is a method of assigning serial numbers in order of downloading of contents.

The subroutine management table 203 includes various items containing basic configuration 211 required to realize basic functions of the mobile device 101 such as function of selecting processing in accordance with a state of compile of each subroutine and expanded configuration 213 included to realize accompanying functions such as management of hash value.

The basic configuration 211 of the subroutine management table 203 includes various items containing content ID column 215, subroutine ID column 217, JIT flag column 219, priority column 221, cache column 223, first code address column 225 and processing address column 227.

Content ID for each of the contents 107 managed by the content management table 201 is stored in the content ID column 215.

ID for identifying each subroutine contained in the contents 107 is stored in the subroutine ID column 217. As the ID assignment method, there are a method of making the service provider uniquely assign IDs common to various services such as content downloading service available in the mobile device 101 and a method of assigning IDs used only in the mobile device 101 originally by the mobile device 101 or the service provider. In the latter case, for example, there is a method of assigning serial numbers from the top of subroutines or random numbers upon downloading of content or first execution of content.

JIT flags representing compile state (kinds of existing codes) of each subroutine is stored in the JIT flag column 219. The kinds and the meaning of the JIT flags are as follows:
(1) yes: JIT compiled and native code 131 exists.
(2) pre: precompiled and second code 121 exists.
(3) no: not compiled and first code 119 exists.
(4) req: not compiled (but request of compile issued from processor 113) and first code 119 exists.

When a subroutine is called up during execution of the content 107, the following processing is performed in accordance with the status of JIT flag for each subroutine.
(1) yes: the processor 113 jumps to native code of reference destination. After the second time, address of called destination is entered in code of calling source in order to permit the calling source directly access to the called destination.
(2) pre: the processor 113 calls up JIT compiler 159. After completion of compile, processor 113 jumps to native code.
(3) no: the processor 113 calls up interpreter.
(4) req: the processor 113 calls up interpreter. Separately therefrom, the subroutine management circuit 171 makes the precompile circuit 173 produce second code 121 from first code 119.

Priority of precompile for each subroutine used as judgment material for deciding subroutine information (hereinafter referred to as “entry”) transferred from the subroutine management table 203 to the subroutine management table cache 205 and judgment material for deciding a control method of the precompile circuit 173 is stored in the priority column 221. In the embodiment, the number of times of called operations (number of times of references) for each subroutine called up during execution of the content 107 is used as the priority. Accordingly, each time subroutine is called up, 1 is added to the priority.

As a point to notice when the priority is treated, the range of storable priority (number of digits) is limited even in any of the memory 117 and the cache memory 177. In the method of coping with this problem, an upper limit of the priority to be stored may be decided and when the priority of any subroutine reaches the upper limit, the priority of all subroutines may be made small in accordance with predetermined standard. For example, a method of subtracting fixed value from each priority and a method of dividing each priority by fixed value are available thereto. Adjustment processing of the priority may be performed, for example, when the processor 113 is idle so as to reduce the overhead of processing.

The cache column 223 has state column 231 and number-of-times column 233 as sub-items in order to manage cache state of each entry to the subroutine management table cache 205. A flag representing whether each entry exists in the subroutine management table cache 205 or not is stored in the state column 231. When the flag is “yes”, it represents that entry exists in the subroutine management table cache 205 and when the flag is “no”, it represents that entry does not exist in the subroutine management table cache 205. The number of times of reading-in operations of each entry into the cache memory 177 is stored in the number-of-times column 233.

The top address of the first code of each subroutine is stored in the first code address column 225.

A memory address representing execution start position of native code 131 (top address) is stored in the processing address column 227 when there is the native code 131 and the top address of second code 121 is stored in the processing address column 227 when there is the second code 121.

Contents to be changed in the subroutine management table 203 are rewritten by the subroutine management circuit 171 under control of the processor 113 which executes the subroutine management program 133. The subroutine management circuit 171 provides various functions described later in addition to the above processing.

Next, the expanded configuration 213 of the subroutine management table 203 is described. The expanded configuration 213 includes 4 kinds of tables containing hash value management table 237, first code size management table 239, download source management table 241 and subroutine sharing table 243. These tables are combined properly according to necessary function to be utilized.

The hash value management table 237 includes various items containing subroutine ID column 245 and hash value column 247.

Subroutine IDs of subroutines are stored in the subroutine ID column 245. Hash values given to first codes of the subroutines are stored in the hash value column 247. As the production method of the hash value, for example, a method of producing the hash value using the hash function on the basis of all sentences of first code 119 and a method of producing the hash value using the hash function on the basis of value of one byte extracted at minimum intervals at which change in each first code can be detected are available. The minimum interval at which the change can be detected is an interval of several to several tens of bytes, for example. The hash value may be given on the side of server which provides the content 107 or may be given in accordance with the above method in the mobile device 101.

The first code size management table 239 includes various items containing subroutine ID column 251 and first code size column 253. Subroutine IDs of the subroutines are stored in the subroutine ID column 251. Sizes of first code of the subroutines are stored in the first code size column 253.

The download source management table 241 includes various items containing server URL column 255, subroutine ID column 257 and server notification column 259 and manages information concerning servers of download sources of the content 107 containing subroutine.

URLs of servers of download sources are stored in the server URL column 255. Subroutine IDs of the subroutines are stored in the subroutine ID column 257. Flags indicating whether the servers are notified that the subroutines exist in the mobile device 101 (for example, downloading is completed) or not are stored in the server notification column 259. When the “flag” is “yes”, the server has been notified of it and when the “flag” is “no”, the server is not notified of it.

The subroutine sharing table 243 includes various items containing subroutine ID column 261, sharing number column 263 and corresponding content ID column 265 and is utilized to grasp a plurality of contents 107 sharing subroutines.

Subroutine IDs of subroutines are stored in the subroutine ID column 261. The number of contents utilizing subroutines is stored in the sharing number column 263. Content IDs of contents utilizing subroutines are stored in the corresponding ID column 265.

The subroutine management circuit 171 judges whether the subroutine contained in the content is utilized by another content upon downloading and deletion of the content or not, so that the subroutine sharing table 243 is updated.

The subroutine management table cache 205 includes various items containing content ID column 271, subroutine ID column 273, JIT flag column 275, execution address column 277, priority column and cache out count column 281. The subroutine management table cache 205 contains part or all of contents of the subroutine management table 203 and replacement and rewriting of data are performed between the subroutine management table 203 and the subroutine management table cache 205 by the subroutine management circuit 171 constituting the subroutine management part at predetermined timing.

Content IDs corresponding to subroutines are stored in the content ID column 271. Subroutine IDs of the subroutines are stored in the subroutine ID column 273. JIT flags of the subroutines are stored in the JIT flag column 275. The following addresses are stored in the execution address column 277 in accordance with kinds of JIT flags, that is, kinds of code of subroutines.
(1) yes: top address of native code
(2) pre: top address of second code
(3) no, req: top address of first code

When the JIT flag is changed, the execution address column 277 is rewritten by the subroutine management circuit 171 on the basis of the above standard.

Priority (number of times of references) of each subroutine is stored in the priority column 279 and 1 is added to the priority by the subroutine management circuit 171 each time the subroutine are called up. Cache out count which is value increasing by the same standard as the priority is stored in the cache out count column 281.

Moreover, in the embodiment, values of the priority are held even when content is ended, whereas the cache out count is cleared to 0 upon writing back of entry into the subroutine management table 203 differently from the priority. Consequently, the priority can represent the order of precompile of subroutines in one content 107 and the cache out count can represents the order of precompile of subroutines in the subroutine management table cache 205.

When the cache out count is desired to be held until end of content, a column for recording the cache out count may be provided in the basic configuration 211 of the subroutine management table 203 separately to manage the cache out count for entry written back from the subroutine management table cache 205. Furthermore, the cache out count is not reduced to be smaller than 0 and when it exceeds a fixed value, addition thereto is not made.

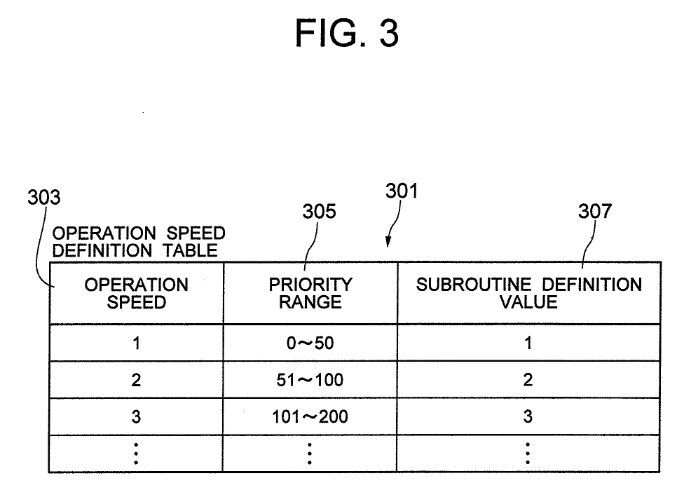

FIG. 3 shows an example of the operation speed definition table 301 for defining operation speed of the precompile circuit 173. This table is utilized so as to make the compile control circuit 175 control the operation speed of the precompile circuit 173 when first code of the subroutine to be precompiled is processed.

The operation speed definition table 301 includes various items containing operation speed column 303, priority range column 305 and subroutine definition value column 307.

Values representing operation speed of the precompile circuit 173 are stored in the operation speed column 303. In the embodiment, this value means that the larger the value is, the higher the operation speed of the precompile circuit 173 is.

The range of priority of subroutine to which the operation speed is applied is stored in the priority range column 305. For example, the first code of subroutine within the range of priority (in embodiment, number of times of references) having 0 to 50 is precompiled by the precompile circuit 173 which operates at corresponding operation speed of “1”.

Values given upon production of first code 119 of each subroutine are stored in the subroutine definition value column 307 on the basis of information of the following items (1) to (3):
(1) time required to convert first code 119 of each subroutine contained in the content 107 into second code 121
(2) time required to convert first code 119 of each subroutine contained in the content 107 into native code 131
(3) frequency with which each subroutine is called up during execution of the content 107

The subroutine definition value given on the basis of the above information can be described in first code 119 by function of compile used when first code 119 such as, for example, Java byte code is produced. For example, the subroutine definition value can be embedded into any place as comment or header information. In the embodiment, when the subroutine definition value is described in first code 119 of subroutine called up during execution of the content 107, the operation speed of the precompile circuit 173 is judged on the basis of the subroutine definition value and when it is not described, the operation speed is judged on the basis of the priority. The first code 119 of subroutine given “3” as the subroutine definition value is compiled by the precompile circuit 173 which operates at operation speed of “3”.

When the operation speed definition table 301 is prepared, it is desirable that the larger the priority of subroutine and the subroutine definition value are, the higher the operation speed of the precompile circuit 173 is. Concretely, there can be adopted a method of increasing clock (operation frequency) of the precompile circuit 173 as the priority of subroutine or the subroutine definition value is increased. Moreover, there can be adopted a method of dividing the clock of the precompile circuit by a large value as the priority of subroutine or the subroutine definition value is decreased.

When the operation speed decided on the basis of the priority of subroutine or the subroutine definition value is low, the precompile control circuit 175 can operate the precompile circuit 173 at low speed, so that the power consumption can be suppressed to be low. In addition, not only the operation speed of the precompile circuit 173 can be made low but also the supply voltage can be reduced within the range of voltage by which operation of the precompile circuit 173 can be maintained, so that the power consumption can be suppressed to be lower.

In the embodiment, the priority for each subroutine and the subroutine definition value are adopted as judgment material for deciding the operation speed of the precompile circuit 173, although any one of them may be adopted as the priority for converting first code 119 of subroutine into second code 121 and the operation speed may be judged on the basis of the value thereof.

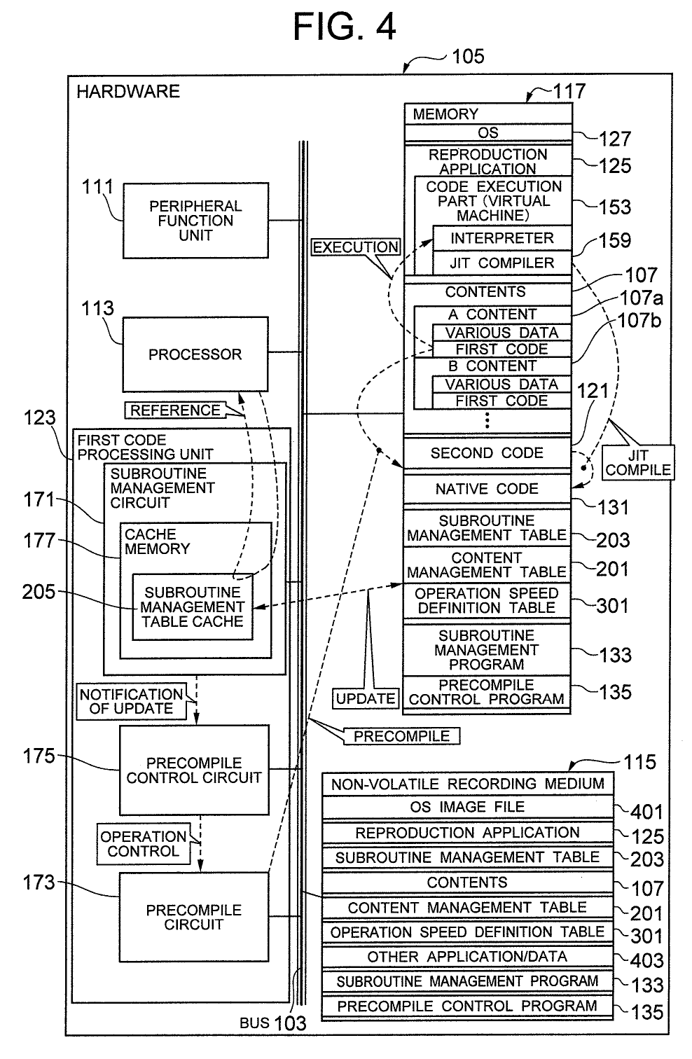

FIG. 4 schematically illustrates configuration of the memory 117, the non-volatile recording medium 115 and the cache memory 177 upon execution of the content 107 and basic operation of the hardware 105 utilizing them.

The memory 117 stores therein content 107, reproduction application 125, operating system 127, second code 121, native code 131, subroutine management table 203, content management table 201, operation speed definition table 301, subroutine management program 133 and precompile control program 135, which are referred to or executed properly upon operation of the mobile device 101. In FIG. 4, a plurality of contents such as A content 107a and B content 107b are stored as the contents 107. Data except the second code 121 and the native code 131 out of the above data stored in the memory 117 are loaded from the non-volatile recording medium 115 into the memory 117 upon starting of the mobile device 101 and the content 107.

The subroutine management table cache 205 including part or all of the subroutine management table 203 is stored in the cache memory 177.

Data of operating system (OS) image 401, reproduction application 125, content 107, other application/data 403, subroutine management program 133, precompile control program 135 and the like are stored in the non-volatile recording medium 115. These data are read in the memory 117 at the timing such as, for example, starting time of the mobile device 101 and the content 107 and change part thereof is written back from the memory 117 at the timing such as power cutting off timing of the mobile device 101 and execution end time of the content 107.

The basic operation of the first code processing unit 123 is now described. First, when calling of subroutine occurs upon execution of the content 107, the processor 113 refers to the subroutine management table cache 205. The subroutine management circuit 171 searches the subroutine management table cache 205 in response to the occurrence of calling of the subroutine and returns information of the subroutine of called destination to the processor 113. The processor 113 executes processing on the basis of the information.

Moreover, the subroutine management circuit 171 updates the subroutine management table cache 205 and notifies the update to the precompile control circuit 175.

The precompile control circuit 175 judges the contents of the update and the state of the system and makes the precompile circuit 173 precompile specific first code 119 to store the produced second code 121 in the memory 117.

The second code 121 is compiled by JIT compiler 159 in the reproduction application 125 at the timing described later and is stored in the memory 117 as native code 131.

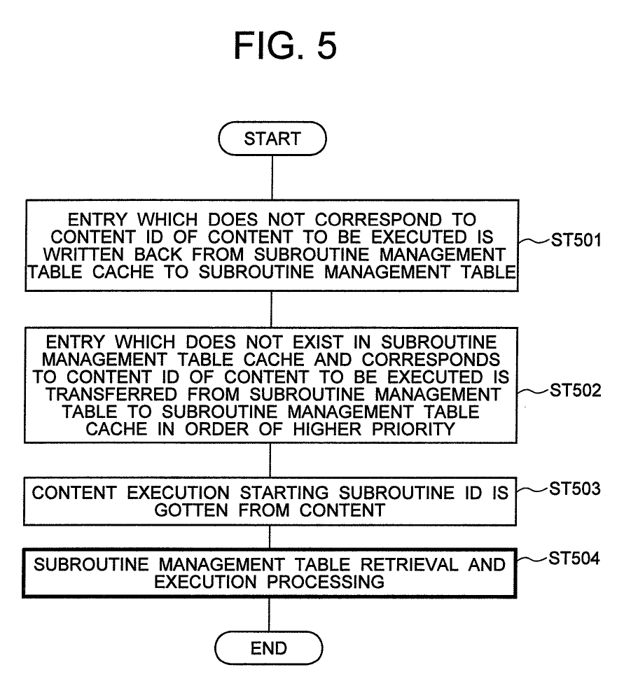

FIG. 5 is a flow chart showing processing of the processor 113 and the subroutine management circuit 171 upon start of execution of the content 107. When the user instructs execution of the content 107 by any trigger such as user's operation of the peripheral function unit 111 such as operation button in the mobile device 101, the processor requests the processing to the subroutine management circuit 171 to start the processing.

Entry which does not correspond to the content ID of the content 107 to be executed is written back from the subroutine management table cache 205 into the subroutine management table 203 (ST 501). Furthermore, when another content except the content 107 to be executed is not executed, it is deemed that there is no entry in the subroutine management table cache 205 and accordingly this step can be omitted.

Entry which does not exist in the subroutine management table cache 205 out of entries corresponding to the content ID of the content 107 to be executed is transferred from the subroutine management table 203 to the subroutine management table cache 205 in order of higher priority (ST 502).

Subroutine ID of subroutine (for example, main routine) to be executed upon start of execution of the content 107 is obtained from the content 107 (ST 503)

After ST 503, the subroutine management table retrieval and execution processing to be executed by the processor 113 and the first code processing unit 123 is started (ST 504).

When the values of entries in the priority column 221 of the subroutine management table 203 are “0” in case where the content 107 is first executed in the mobile device 101, entry of predetermined subroutine in the content 107 to be executed may be transferred to the subroutine management table cache 205 as processing of ST 502. For example, a predetermined number of entries can be transferred in order from the top entry of subroutine contained in the content 107. In this case, subroutines having the called relation are arranged adjacent to each other in the content 107 upon production of first code 119, so that subroutine can be called up efficiently even in first execution to improve the cache efficiency.

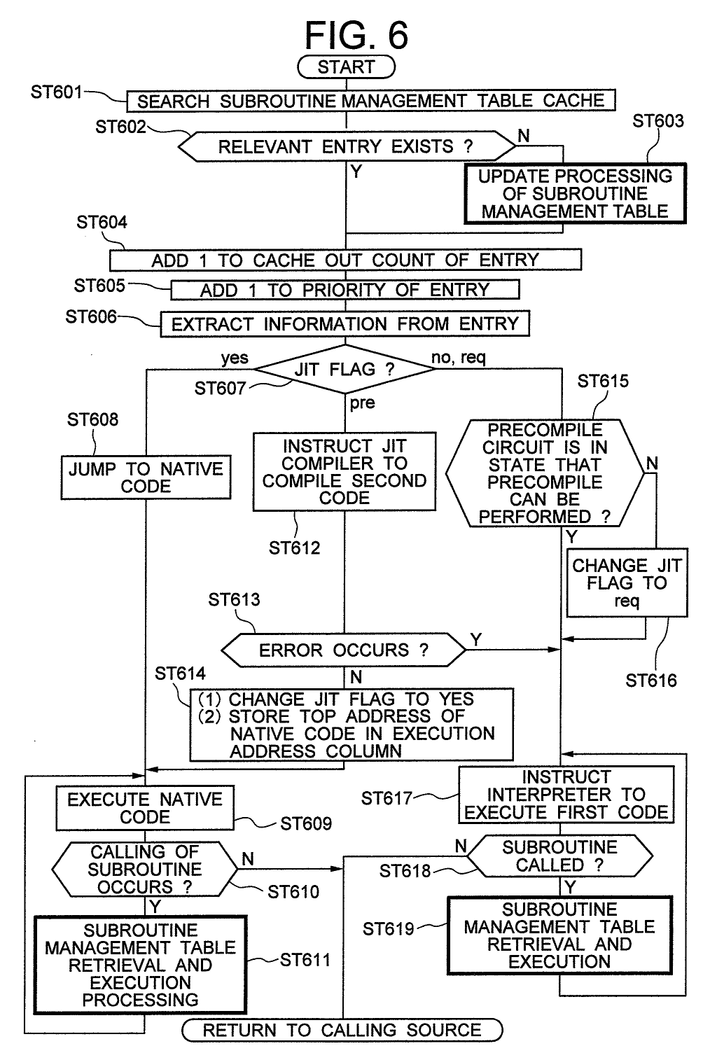

FIG. 6 is a flow chart showing the subroutine management table retrieval and execution processing (ST 504 of FIG. 5) by the processor 113 and the subroutine management circuit 171. In this processing, when subroutine is called up, information of the relevant subroutine is extracted from the subroutine management table 203 and the subroutine management table cache 205 to select the processing system and each code is executed in accordance with the processing system.

When subroutine is called up, the subroutine management circuit 171 searches the subroutine management table cache 205 for the relevant subroutine by means of subroutine ID (ST 601) and judges whether the relevant entry exists or not (ST 602). This search may be performed by the processor 113, although as in the embodiment when the subroutine management circuit 171 performs this search, the processor 113 can execute other processing containing I/O and the like until the search is completed.

As a result of the search, when there is no relevant entry (when judgment of ST 602 is “N”), the subroutine management circuit 171 executes processing of updating the subroutine management table cache described later (ST 603) and processing proceeds to ST 604. When there is the relevant entry (when judgment of ST 602 is “Y”), the subroutine management circuit adds “1” to the cache out count of the entry (ST 604) and adds “1” to the priority of the entry (ST 605). This addition processing of the cache out count and the priority may be executed by the processor 113.

Next, the subroutine management circuit 171 extracts information of JIT flag from the entry (ST 606) and the processing branches to execute different processing in accordance with the value thereof (ST 607). When the JIT flag is “yes”, the top address of native code 131 of subroutine is gotten from the subroutine management table cache 205 as an execution address of the relevant entry and is delivered to the processor 113. Consequently, the processor 113 jumps to the native code 131 of the subroutine to be executed (ST 608) and executes the native code (ST 609). When the processing in ST 608 or ST 609 is performed, the code of calling source may be changed and an address of jump destination may be written additionally so that the code of calling source can jump to the native code 131 of the subroutine in order to make calling after the second calling at high speed. The writing processing of code may be made by any of the processor 113 and the subroutine management circuit 171.

The processor 113 judges whether there is calling of another subroutine during execution of native code 131 of subroutine or not (ST 610) and when calling of another subroutine further occurs (when judgment of ST 610 is “Y”), the subroutine management table retrieval and execution processing is recurrently performed (ST 611) and the processing in ST 609 and 610 is performed repeatedly. On the other hand, when the processor 113 completes execution of the native code 131 of subroutine and another subroutine is not called up (when judgment of ST 610 is “N”), the processor 113 returns to processing of the subroutine of calling source.

In judgment of ST 607, when it is judged that JIT flag is “pre”, the subroutine management circuit 171 delivers the top address of second code 121 of the subroutine to the processor 113 as an execution address of the subroutine management table cache 205. The processor 113 makes the JIT compiler 159 compile the second code 121 in response thereto (ST 612) and examines whether any error occurs or not (ST 613). The contents of error are considered to be the case where the memory area for storing native code is lacking and the case where compile error occurs, for example. The native codes produced by the JIT compiler 159 are stored in the memory 117 by the JIT compiler 159 successively or in a lump after JIT compile is completed.

When error occurs during JIT compile (when judgment of ST 613 is “Y”), the processor 113 makes the interpreter 157 execute the first code 119 corresponding to the second code 121 (ST 617).

When no error occurs during JIT compile (when judgment of ST 613 is “N”), the processor 113 notifies it to the subroutine management circuit 171. The subroutine management circuit 171 changes the JIT flag in the subroutine management table cache 205 to “yes” and records the top address of the produced native code 131 as an execution address (ST 614). The processor 113 jumps to the native code 131 produced by the JIT compiler 159 and executes it (ST 609). Then, the processing from ST 609 to ST 611 is performed repeatedly as described above. Storing of the native code 131 into the memory 117 may be made after conversion into native code 131 is completed as shown in FIG. 6 or the compiled codes may be stored successively.

When it is judged that the JIT flag is “no” or “req” in the judgment of ST 607, the subroutine management circuit 171 judges whether the precompile circuit 173 precompiles the first code 119 of another subroutine or not, that is, whether the precompile circuit 173 is in the state that it can perform precompile immediately or not (ST 615). Such judgment can be performed using information such as so-called flag indicating whether the precompile circuit 173 precompiles the first code 119 of any subroutine or not.

When the subroutine management circuit 171 judges that precompile cannot be performed immediately since the precompile circuit 173 precompiles the first code 119 of another subroutine (there is an entry of another subroutine indicating that JIT flag is “req”), the subroutine management circuit 171 changes the JIT flag of the subroutine management table cache 205 to “req” (ST 616) and sets it to the precompile waiting state. In this case, the second codes 121 are successively produced from the first codes 119 of the subroutine selected by the method described later. When the JIT flat is judged to be “req” in the judgment of ST 607, it indicates that the called-up subroutine has been called before and the first code 119 thereof is not yet converted into the second code 121 (in the pecompile waiting state). In this case, the JIT flag (req) may be constructed to be maintained in the processing of ST 616.

On the other hand, when the subroutine management circuit 171 judges that the precompile circuit 173 can perform precompile (when judgement of ST 615 is “Y”), the subroutine management circuit 171 makes the precompile circuit 173 produce the second code 121 from the first code 119 of the subroutine to be processed.

Thereafter, the subroutine management circuit 171 extracts the top address of the first code 119 of the subroutine from the subroutine management table cache 205 as execution address of the called-up subroutine and delivers it to the processor 113. The processor 113 makes the interpreter 157 execute the first code 119 on the basis of the execution address of the first code (ST 617).

The processor 113 judges whether calling of another subroutine further occurs or not while the interpreter 157 is made to execute the first code 119 (ST 618) and when calling of another subroutine further occurs (when judgment of ST 618 is “Y”), the processor 113 executes the subroutine management table retrieval and execution processing recurrently and the processing in ST 617 and 618 is performed repeatedly. On the other hand, when the processor 113 completes the processing (ST 617) by the interpreter 157 and another subroutine is not called up (when judgment of ST 618 is “N”), the processing is returned to processing of the subroutine of calling source.

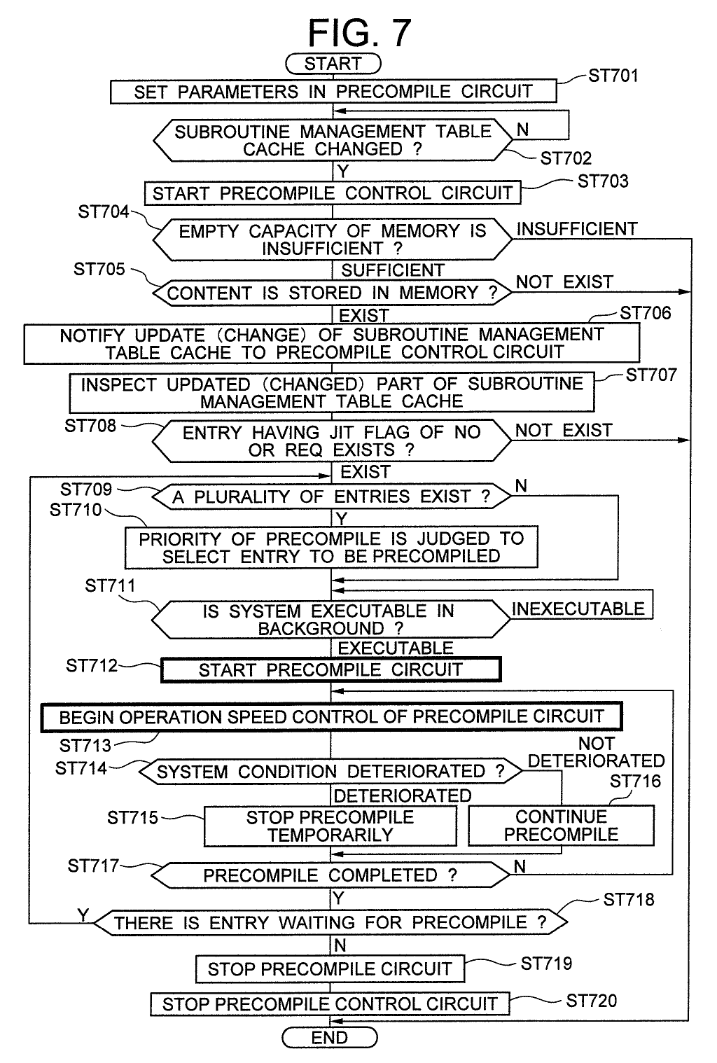

FIG. 7 is a flow chart showing operation of the first code processing unit 123 upon precompile. First, when the mobile device 101 is started, initial setting of parameters is performed to the precompile control circuit 175 (ST 701). The setting of parameters may be performed by any of the subroutine management circuit 171 and the processor 131. The parameters contain, for example, values of the operation speed definition table 301. Since the operation speed definition table 301 is stored in the memory 117, the processing of setting the parameters may be omitted. And the precompile control circuit 175 may refer to the operation speed definition table 301 stored in the memory 117 if necessary. Moreover, the operation speed definition table 301 may be stored in the cache memory 177 and reference may be made thereto.

When the setting of the parameters (ST 701) is completed, the subroutine management circuit 171 waits until the contents of the subroutine management table cache 205 are changed (updated) (when judgment of ST 702 is “N”) and when the subroutine management circuit detects that the subroutine management table cache 205 is changed (updated) (when judgment of ST 702 is “Y”), the precompile control circuit 175 is started (ST 703).

Next, the subroutine management circuit 171 examines whether an empty capacity of the memory 117 is insufficient or not (ST 704). When the empty capacity of the memory 117 is insufficient, the processing is ended. As a judgment method of the empty capacity of the memory 117, for example, a method of judging that the memory capacity is insufficient when the occupancy amount of the memory 117 exceeds a predetermined threshold is available.

When the empty capacity of the memory 117 is sufficient, the subroutine management circuit 171 examines whether content 107 utilizing the subroutine to be precompiled is stored in the memory 117 or not (ST 705). In ST 705, when the relevant content 107 is not stored in the memory 117, the processing is ended.

When the content 107 is stored in the memory 117, the subroutine management circuit 171 notifies update (change) of the subroutine management table cache 205 to the precompile control circuit 175 (ST 706).

When the precompile control circuit 175 receives the notification from the subroutine management circuit 171, the precompile control circuit 175 inspects the updated (changed) part of entry in the subroutine management table cache 205 (ST 707) and examines whether there is an entry having the JIT flag of “no” or “req” (ST 708).

When there is no entry having the JIT flag of “no” or “req”, the processing is ended. When there is the entry having the JIT flag of “no” or “req”, the subroutine management circuit 171 examines whether there are a plurality of entries to be precompiled or not, that is, whether there are a plurality of entries having the JIT flag of “req” (ST 709).

When there are the plurality of entries to be precompiled (when judgment of ST 709 is “Y”), the subroutine management circuit 171 judges the priority of precompile to select the entry to be precompiled (ST 710). The value in the priority column 279 of the subroutine management table cache 205 or the subroutine management table 203, for example, may be adopted as the priority. In this case, the first code 119 is desirably converted into the second code 121 in order from the subroutine having higher priority.

When there is only one entry to be precompiled (when judgment of ST 709 is “N”) or when the entry to be precompiled is selected in ST 710, the precompile control circuit 175 examines whether the system is in the system condition where precompile can be executed in the background for execution of interpreter or not (ST 711). The case where the precompile cannot be executed in the background is considered to be, for example, as follows:
(1) the case where load on the bus 103 is heavier than predetermined threshold, and
(2) the case where the frequency of accesses by the processor 113 to the memory 117 in which first code 119 to be precompiled is stored is higher than predetermined threshold in case where plural memories 117 are provided.

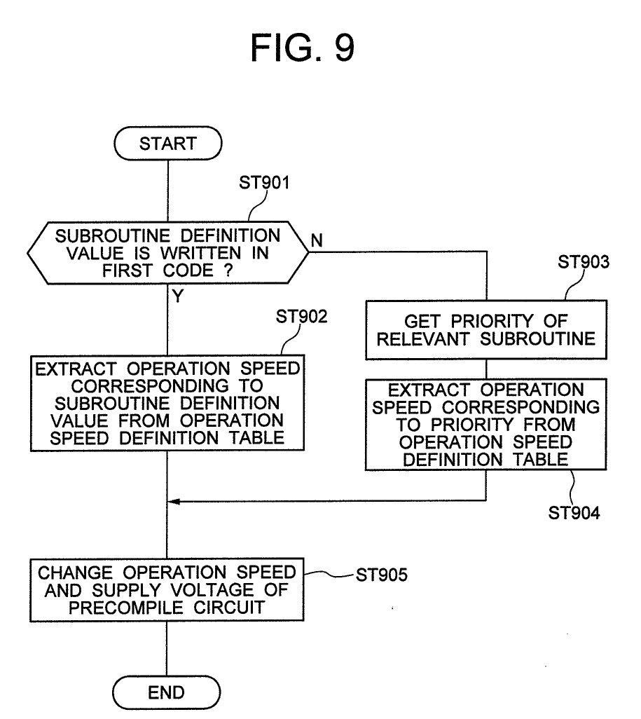

In ST 711, when it is judged that the precompile cannot be executed in the background for execution of interpreter, the precompile control circuit 175 waits until the system condition is recovered. When it is judged that the precompile can be executed in the background for execution of interpreter, the precompile control circuit 175 starts the precompile circuit 173 (ST 712) and begins the operation speed control of the precompile circuit 173 (ST 713) described later (FIG. 9).

When the precompile control circuit 175 begins the operation speed control of the precompile circuit 173, the precompile control circuit 175 monitors the system condition and examines whether the system condition is deteriorated or not (ST 714). When the system condition is deteriorated, the precompile control circuit makes the precompile circuit 173 stop precompile temporarily (ST 715). The deterioration of the system condition is considered to contain the case where load on the bus 103 is heavier than predetermined threshold and the case where the frequency of accesses by the processor 113 to the memory 117 in which first codes 119 to be precompiled are stored is higher than predetermined reference when plural memories 117 are provided.

In ST 714, when the system condition is not deteriorated, the precompile control circuit 175 makes the precompile circuit 173 continue precompile (ST 716) and judges whether the precompile is completed or not (ST 717). When the precompile is not completed (when judgment of ST 717 is “N”), the processing is returned to ST 713. When the precompile is completed (when judgment of ST 717 is “Y”), the subroutine management circuit 171 judges whether there is entry of another subroutine waiting for precompile or not (ST 718).

When there is entry of another subroutine waiting for precompile (when judgment of ST 718 is “Y”), the processing is returned to ST 709. When there is no entry of another subroutine waiting for precompile (when judgment of ST 718 is “N”), the precompile control circuit 175 stops the precompile circuit (ST 719). Operation of the precompile control circuit 175 is stopped (ST 720) and the processing is ended.

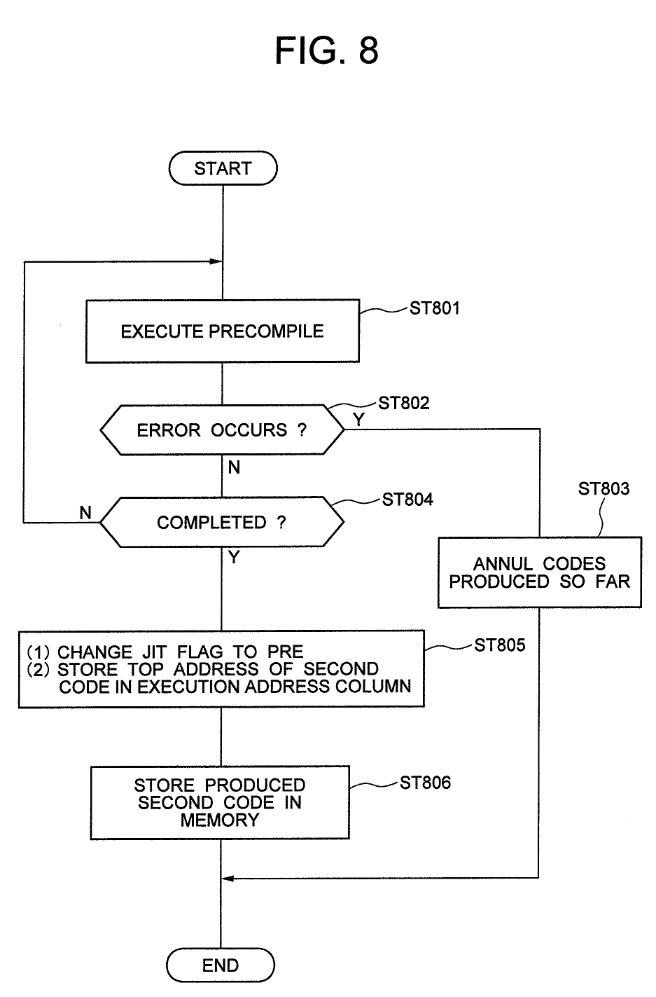

FIG. 8 is a flow chart showing processing performed by the precompile circuit 173 during period from beginning to end of precompile. This processing begins by starting the precompile circuit 173 by the precompile control circuit 175 (ST 712 of FIG. 7).

When the precompile circuit 173 begins precompile of first code 119 of subroutine to be processed (ST 801), the precompile circuit 173 detects whether error occurs or not (ST 802). When error occurs (when judgment of ST 802 is “Y”), the precompile circuit annuls codes produced so far (ST 803) and stops the precompile. As the contents of error, for example, there are considered the case where memory area for storing second code is lacking and the case where compile error occurs because wrong value is set in first code.

On the other hand, when the precompile is ended normally (when judgment of ST 802 is “N” and judgment of ST 804 is “Y”), the precompile circuit 173 instructs the subroutine management circuit 171 to perform the following (ST 805):
(1) change JIT flag to “pre” and
(2) store the top address of second code 121 of subroutine in the execution address column 277.

The subroutine management circuit 171 changes the JIT flag of the subroutine management table cache 205 to “pre” and store the top address of the produced second code 121 in the execution address column 277 in response to the instruction.

The precompile circuit 173 stores the produced second code 121 in the memory 117 (ST 806). As the storing method of the second code 121 in the memory 117, the second codes 121 produced during precompile may be stored in the memory 117 successively. Moreover, the main routine is often executed only once during execution of the content 107 and accordingly the main routine may be executed only by the interpreter without performing precompile.

FIG. 9 is a flow chart showing the operation speed control of the precompile circuit 173 by the precompile control circuit 175.

The precompile control circuit 175 examines whether the subroutine definition value is written in the first code 119 or not (ST 901) when the precompile circuit 173 performs precompile of the first code 119 (for example, ST 716 of FIG. 7). When the subroutine definition value exists in the first code 119 (when judgment of ST 901 is “Y”), the subroutine definition value is collated with the operation speed definition table (FIG. 3), so that the operation speed corresponding to the value is extracted (ST 902).

When the subroutine definition value does not exist in the first code 119 (when judgment of ST 901 is “N”), the priority of subroutine corresponding to the first code 119 is extracted from the subroutine management table cache 205 (ST 903) and the extracted priority is collated with the operation speed definition table (FIG. 3), so that the operation speed corresponding to the priority is extracted (ST 904).

The precompile control circuit 175 controls the operation speed of the precompile circuit 173 in accordance with the operation speed extracted in ST 902 or ST 904 and when the operation speed is reduced, the precompile control circuit 175 reduces a supply voltage to the precompile circuit 173 within the range of voltage by which operation of the precompile circuit 173 can be maintained (ST 905).

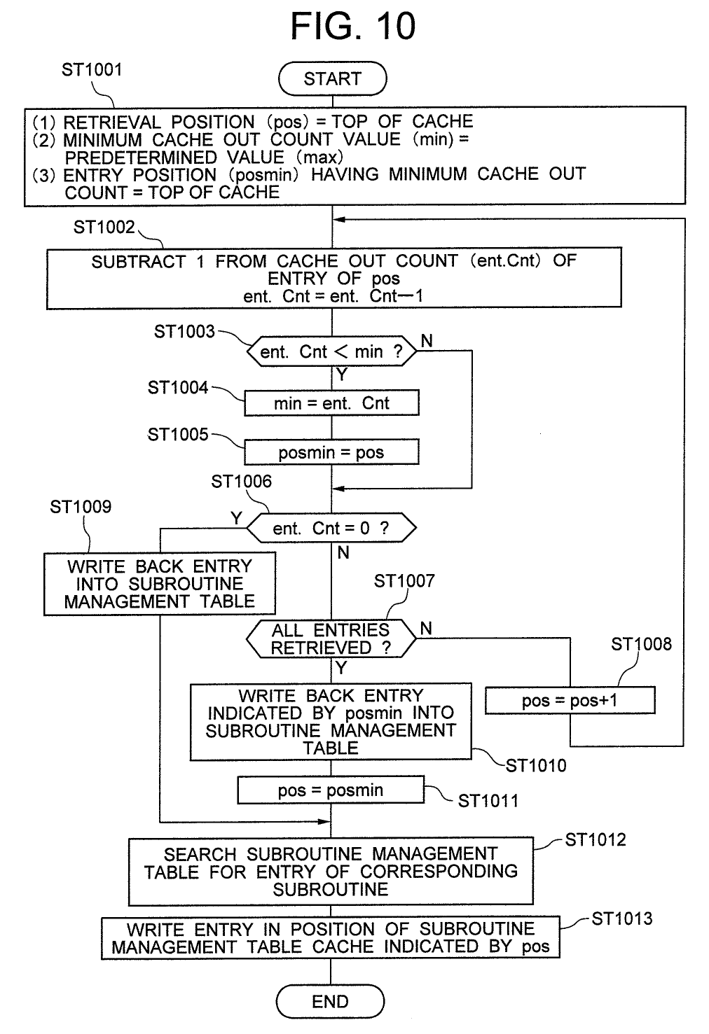

FIG. 10 is a flow chart showing update processing (ST 603 of FIG. 6) of the subroutine management table cache 205 by the subroutine management circuit 171. In this processing, replacement of data between the subroutine management table 203 and the subroutine management table cache 205 is performed if necessary when subroutine is called up.

When this processing is started, parameters are initialized as follows (ST 1001):
(1) retrieval position [pos]=top of cache
(2) minimum cache out count [min]=predetermined value (for example, maximum value [max] of storable cache out count)
(3) entry position [posmin] having minimum cache out count=top of cache

Then, 1 is subtracted from cache out count [ent.Cnt] of entry [ent] of pos (ST 1002) and it is judged whether the subtracted result is smaller than the minimum cache out count [min] or not (ST 1003).

When ent.Cnt is smaller than min (when judgment of ST 1003 is “Y”), ent.Cnt is set to min (ST 1004) and pos is set to posmin (ST 1005).

When ent.Cnt is larger than min (when judgment of ST 1003 is “N”) or after ST 1005, it is judged whether ent.Cnt is 0 or not (ST 1006) and when ent.Cnt is not 0 (when judgment is “N”), it is judged whether all entries have been retrieved or not (ST 1007). When all entries have not been retrieved (when judgment of ST 1007 is “N”), 1 is added to pos (ST 1008) and the above processing is performed for next entry.

When ent.Cnt is 0 (when judgment of ST 1006 is “Y”), the entry is written back into the subroutine management table 203 (ST 1009). Moreover, when all entries have been retrieved (when judgment of ST 1007 is “Y”), the entry of posmin is written back into the subroutine management table 203 (ST 1010) and posmin is set to pos (ST 1011).

According to the above processing, entry having minimum cache out count is detected as entry which is hardly referred to and entry to be written back into subroutine management table 203 from subroutine management table cache 205 can be judged rationally.

After ST 1009 or ST 1011, the subroutine management table 203 is searched for entry corresponding to subroutine to which the processor 113 is to refer (ST 1012) and this entry is written in a position of the subroutine management table cache 205 indicated by pos (ST 1013), so that the update processing of the subroutine management table cache 205 is ended.

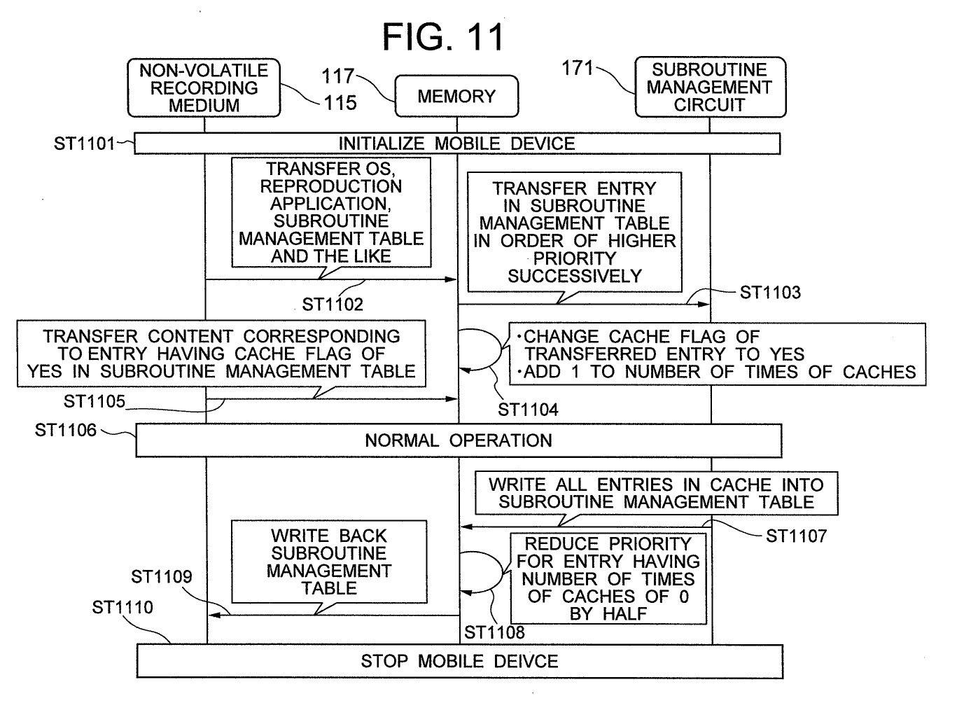

FIG. 11 is a sequential chart showing basic operation of the mobile device 101. This sequential chart shows the flow of processing until the system is stopped after the mobile device 101 is started (power supply is turned on).

First, when the mobile device 101 is started, the processor 113 initializes the mobile device 101 (ST 1101). In this processing, a variety of hardware 105 is initialized and the contents of the memory 117 are cleared.

When the initialization is completed, the processor 113 transfers operating system 127, reproduction application 125, content management table 201, subroutine management table 203 and operation speed definition table 301 from the non-volatile recording medium 115 to the memory 117 (ST 1102).

The subroutine management circuit 171 transfers entries in the subroutine management table 203 to the subroutine management table cache 205 in the cache memory 177 in order of higher priority (in the embodiment, number of times of references) (ST 1103). When the transfer is completed, the subroutine management circuit 171 changes the state column 231 of sub-items of the cache column 223 of the entries transferred from the subroutine management table 203 to “yes” and adds “1” to the number-of-times column 233 thereof (ST 1104).

Next, the processor 113 transfers the content 107 corresponding to entry having the cache flag (state column 231) of “yes” in the subroutine management table 203 from the non-volatile recording medium 115 to the memory 117 (ST 1105). When the transfer is completed, normal operation such as execution of content 107 by the processor 113 and the first code processing unit 123 is performed (ST 1106).

When an end instruction (turning off of power supply or the like) for the mobile device 101 is issued, for example, by means of user's operation on the way of the normal operation (ST 1106), the subroutine management circuit 171 writes back all entries in the subroutine management table cache 205 into the subroutine management table 203 (ST 1107). The subroutine management circuit 171 reduces to half the priority value for entry having the number of times of caches of “0” in the subroutine management table 203 by half (ST 1108). Consequently, the priority of precompile for entry having low utilization frequency can be reduced. The reduction by half is an example and a fixed value may be subtracted from the priority or the priority may be divided by a fixed value, for example.

After ST 1108, the processor 113 writes back the subroutine management table 203 into the non-volatile recording medium 115 (ST 1109) and stops operation of the mobile device 101 (ST 1110). In this case, changed part of the subroutine management table 203 may be written back into the non-volatile recording medium 115.

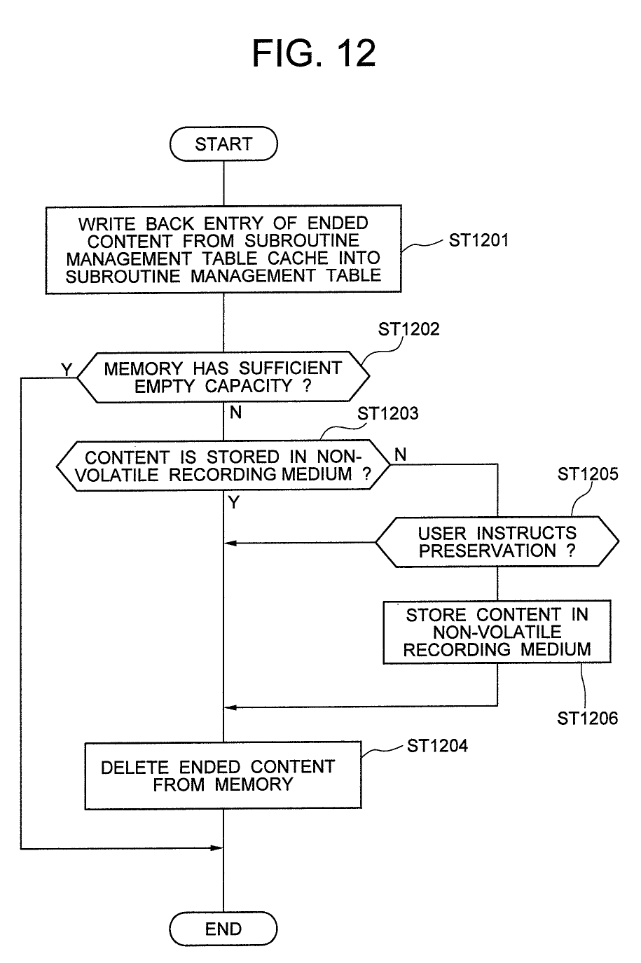

FIG. 12 is a flow chart showing content ending processing performed by the subroutine management circuit 171. This processing is performed at any timing out of timing that end of the content 107 is instructed by the user, timing that another content is executed and timing that another content is downloaded from server to be executed. Since the mobile device 101 of the embodiment is a built-in apparatus of portable type, resources of hardware 105 such as processor 113 and memory 117 are restricted strictly and accordingly when another content is executed, this ending processing is performed forcedly to end the content 107 being executed.

First, when an end instruction for content 107 is issued, entry corresponding to the content 107 to be ended is written back from subroutine management table cache 205 into the subroutine management table 203 (ST 1201). Then, it is examined whether an empty capacity of the memory 117 is sufficient or not (ST 1202). The state that the capacity is sufficient means that the memory 117 can load therein another content, for example. When the memory 117 has sufficient empty capacity (when judgment of ST 1202 is “Y”), the content ending processing is ended.

When the memory 117 does not have sufficient empty capacity (when judgment of ST 1202 is “N”), it is judged whether the content 107 is stored in the non-volatile recording medium 115 or not (ST 1203). When the content 107 is stored in the non-volatile recording medium 115 (when judgment of ST 1203 is “Y”), the content 107 is deleted from the memory 117 (ST 1204) and the content ending processing is ended.

When the content 107 is not stored in the non-volatile recording medium 115 (when judgment of ST 1204 is “N”), it is judged whether preservation instruction is issued by the user or not (ST 1205). When there is the preservation instruction by the user (when judgment of ST 1205 is “Y”), the content 107 is stored in the non-volatile recording medium 115 (ST 1206) and then deleted from the memory 117 (ST 1204), so that the content ending processing is ended.

On the other hand, when there is no preservation instruction by the user (when judgment of ST 1205 is “N”), the content 107 is deleted from the memory 117 (ST 1204) and the content ending processing is ended. In the processing of ST 1204, when it is judged on the basis of the subroutine sharing table 243 that the first code 119 of the content 107 to be ended is shared with another content, the shared first code 119 may be stored in the memory 117.

The processing of ST 1202 to ST 1206 may be performed by the processor 113.

When the foregoing description (FIGS. 1 to 12) is summarized, the mobile device 101 of the embodiment has the following configuration:
(1) There is provided the memory 117 for storing therein the subroutine management table 203 which manages kinds of existing codes out of the native code 131 executable by the processor 113, the first code (Java byte code) 119 which is source of the native code 131 and does not depend on operating system and the second code 121 produced in the process of compiling the first code 119 into the native code 131 for a plurality of subroutines contained in Java program (content) 107. The memory 117 stores therein the operation speed definition table for defining operation speed of the precompile circuit 173 in accordance with the priority defined on the basis of predetermined standard for each subroutine to produce the second code 121 from the first code 119.
(2) There is provided the cache memory 177 for storing therein part of contents of the subroutine management table 203 as the subroutine management table cache 205.
(3) There is provided the virtual machine 153 including the interpreter 157 for executing the first code 119 by the interpreter method and the JIT compiler 159 for executing the second code 121 after compile thereof.
(4) There is provided the precompile circuit 173 for producing the second code 121 from the first code 119.
(5) There is provided the subroutine management part (subroutine management program 133 and subroutine management circuit 171) for performing execution control so that as a result of referring to the subroutine management table cache 205 for the subroutine called up during execution of the content 107, when there is the native code 131, the native code 131 is executed by the processor 113 and when there is the second code 121, the second code 121 is executed by the JIT compiler 159 of the virtual machine 153 and the produced native code 131 is stored in the memory 117 or when there is the first code 119, the first code 119 is executed by the interpreter 157 of the virtual machine 153 and is converted into the second code 121 by the precompile circuit 173 to store the second code 121 in the memory 117.
(6) The subroutine management circuit 171 performs recording control so that when kind of code of subroutine is changed by the above control, the changed kind is stored in the subroutine management table cache 205. In the recording control, the subroutine management circuit 171 performs control so that the number of times of called operations of each subroutine called up during execution of the content 107 is recorded in the subroutine management table cache 205 as the priority.
(7) The subroutine management circuit 171 performs cache control so that transfer and rewriting of data between the subroutine management table 203 and the subroutine management table cache 205 are performed at predetermined timing such as upon starting of content 107 and upon calling of subroutine.
(8) The subroutine management circuit 171 performs execution control so that the first code 119 is converted into the second code 121 in order from subroutine having higher priority defined on the basis of predetermined standard for each subroutine to convert the first code 119 into the second code 121 under control of the processor 113 which executes the subroutine management program 133.
(9) There is provided the precompile control part (precompile control program 135 and precompile control circuit 175) for performing control so that operation speed is judged from the operation speed definition table 301 using the priority of subroutine and the precompile circuit 173 is operated in accordance with the operation speed. Furthermore, when the operation speed of the precompile circuit 173 is reduced, the precompile control circuit 175 reduces the supply voltage to the precompile circuit 173 within a range of voltage by which operation of the precompile circuit 173 can be maintained. In the embodiment, the number of times of called operations for each subroutine called up during execution of the content 107 is adopted as the priority.
(10) The subroutine management circuit 171 performs cache control so that information of subroutine contained in the content 107 to be executed is written from the subroutine management table 203 to the subroutine management table cache 205 in order of higher priority when the priority is recorded in the subroutine management table 203 upon execution of content. Furthermore, the subroutine management circuit 171 performs cache control so that information of subroutine having the lowest priority (in the embodiment, cache out count which is the number of times of references of each entry and is cleared each time cache out is made) in the subroutine management table cache 205 is written back into the subroutine management table 203 and information of the called-up subroutine is written from the subroutine management table 203 into the subroutine management table cache 205 when information of the called-up subroutine is not contained in the subroutine management table cache 205 during execution of content 107.

As described above, the processing (precompile) of converting the first code 119 into the second code 121 is performed using the circuit (precompile circuit 173) dedicated to precompile, so that precompile can be performed perfectly independent of (without using the processor 113) the processing of the first code 119 by the interpreter 157. Accordingly, since the processing by the precompile circuit 173 and the processing by the interpreter 157 can be performed simultaneously at high speed, the execution speed of the content 107 can be increased. Moreover, since the JIT compiler 159 compiles the previously precompiled second code 121, the processing speed of the JIT compile (production of native code 131) can be improved.

### Embodiment 2

The method of receiving part of existing content 107 or all of new content 1303 from a content delivering server 1301 by means of the mobile device 101 to which the present invention is applied is now described as the embodiment 2. In the embodiment 2, description of the function of the mobile device 101 described in the embodiment 1 is omitted and the like elements to those shown in the embodiment 1 are designated by like reference numerals.

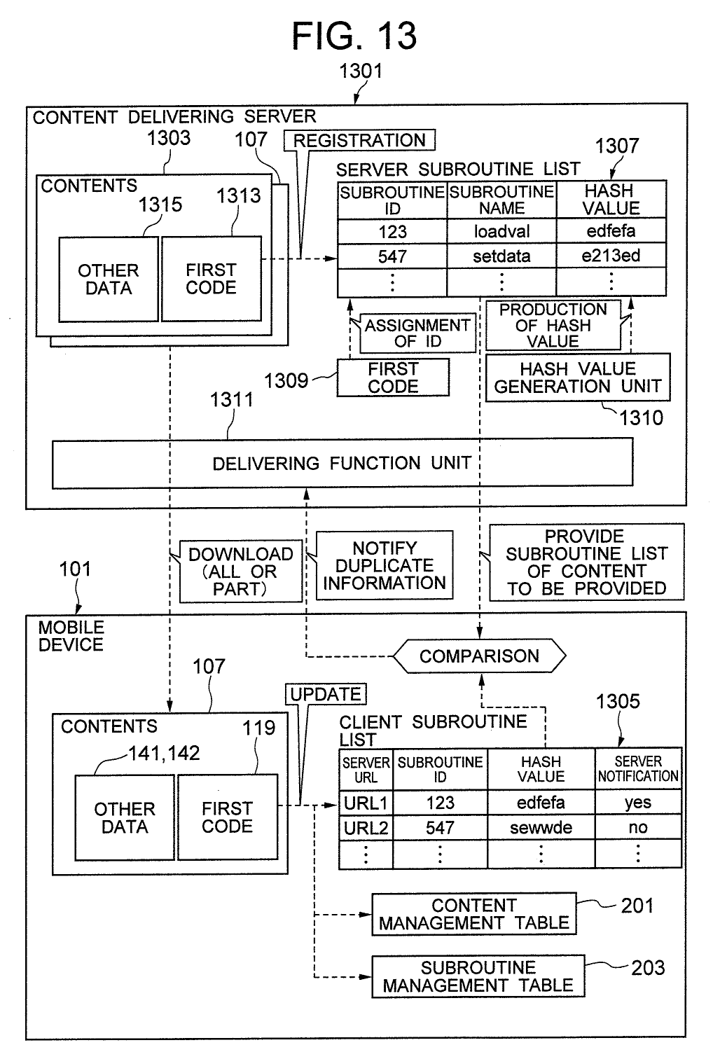

FIG. 13 schematically illustrates configuration of the mobile device 101 and the content delivering server 1301 and a cooperation method thereof. The mobile device 101 and the content delivering server 1301 are connected each other through a communication network such as the Internet.

The mobile device 101 includes client subroutine list 1305 formed by combining the hash value management table 237 and download source management table 241 of the expanded configuration 213 of the subroutine management table 203.

The client subroutine list 1305 stores therein URL (server URL) of download source of each subroutine, subroutine ID, hash value and server notification state. In the embodiment 2, subroutine ID, subroutine name and hash value are given for each subroutine on the side of the content delivering server 1301.

The content delivering server 1301 includes, in addition to a plurality of contents 107 and 1303, a server subroutine list 1307 for managing subroutine ID, subroutine name and hash value for each subroutine contained in the contents 107 and 1303, a subroutine ID counter 1309 for assigning unique ID to each subroutine, a hash value production unit 1310 for producing, when information of each subroutine is first registered in the server subroutine list 1307 and when information of changed subroutine is registered in the server subroutine list 1307, a hash value for the subroutine to be registered in the server subroutine list, and a delivering function unit 1311 including various functions provided usually in Web server and various functions required to make communication of information such as content between the mobile device 101 and the content delivering server 1301.

The content 1303 on the side of the server includes first code 1313 and other data 1315 containing text data and various binary data.

As the production method of the hash values by the hash value production unit 1310, for example, a method of producing hash values using the hash function on the basis of all sentences of first code of each subroutine and a method of producing hash values using the hash function on the basis of value of one byte extracted at minimum intervals in which change of first code 1313 can be detected are available. The minimum interval in which the change can be detected is several to several tens of bytes, for example.

Furthermore, the content delivering server 1301 includes a server content table (not shown) similar to the content management table (FIG. 2) 201 for managing content ID for contents 107 and 1301 and subroutine ID for each subroutine contained in the contents. When the content delivering server 1301 transmits data such as first codes 119, 1313 of subroutine of the contents 107, 1313 to the mobile device 101, the content delivering server 1301 also transmits information of content ID corresponding to each subroutine together.

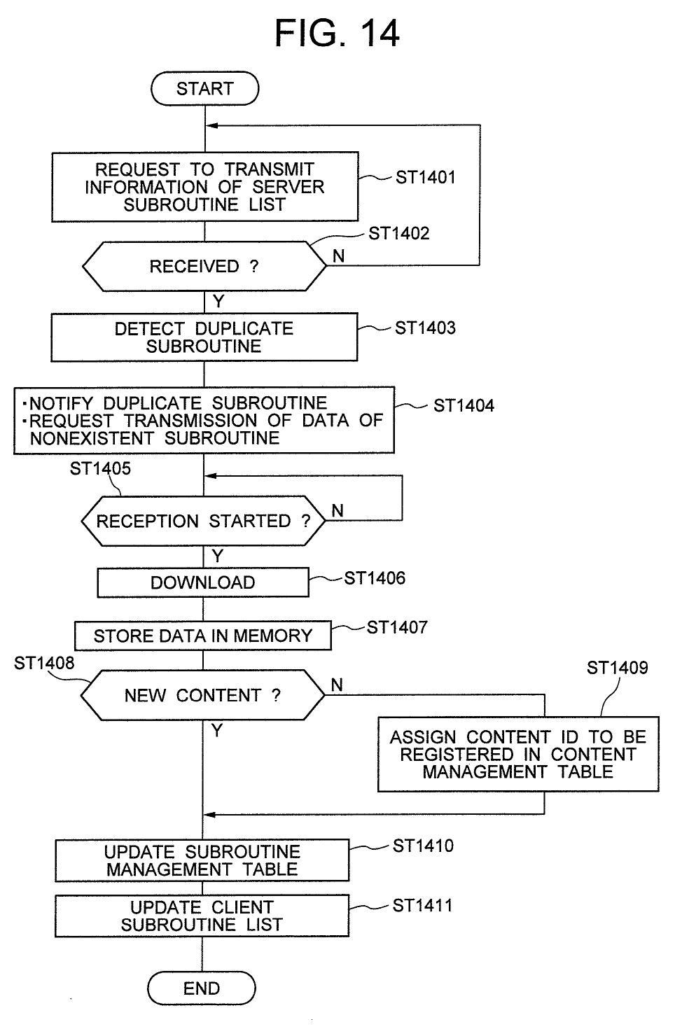

Referring now to FIGS. 13 and 14, the method of making the mobile device 101 download contents 107, 1303 from the content delivering server 1301 is described. FIG. 13 shows the processing described in FIG. 14 and accordingly reference may be made to FIG. 14 properly.

FIG. 14 is a flow chart showing content registration processing by the subroutine management part 171 (FIG. 1) of the mobile device 101. This processing is performed when the mobile device 101 requests the content delivering server 1301 to deliver content in response to user's instruction. Concretely, the processing is performed when the user uses the mobile device 101 to access to a Web site in which a plurality of downloadable contents 107, 1303 are displayed and makes operation of downloading a desired content.

First, the subroutine management circuit 171 requests the content delivering server 1301 to transmit information of the server subroutine list 1307 concerning the content to be downloaded in response to the user's instruction (ST 1401) and waits until the information is transmitted (ST 1402).

When the subroutine management circuit 171 receives the information of server subroutine list 1307 (when judgment of ST 1402 is “Y”), the subroutine management circuit 171 compares the server subroutine list 1307 and the client subroutine list 1305 to detect duplicate subroutine in both lists 1305 and 1307 on the basis of the hash value (ST 1403). When there is no duplicate subroutine, the content is the content 1303 to be downloaded newly.

On the other hand, when there is duplicate subroutine, the content to be downloaded is the content 107 which has been downloaded to the mobile device 101 already and contains subroutine corrected or added after the downloading or the content 1303 which is not downloaded to the mobile device 101 and shares some subroutines with another already installed content.

The subroutine management circuit 171 notifies the duplicate information of subroutine detected in ST 1403 to the content delivering server 1301 (ST 1404) and waits until reception of data transmitted from the server is started (ST 1405). The content delivering server 1301 transmits data such as first codes 119, 1313 of subroutine which is not duplicated. When the subroutine management circuit 171 starts the reception (when judgment of ST 1405 is “Y”), the subroutine management circuit 171 downloads the data to the non-volatile recording medium 115 (ST 1406). When the downloading is completed, the downloaded data is transferred to the memory 117 (ST 1407).

Next, the subroutine management circuit 171 judges whether the downloaded data is data of new content or not (ST 1408). When data 1313, 1315 of new content 1303 is downloaded (when judgment of ST 1408 is “Y”), a content ID is assigned to the content 1303 and the information is registered in the content management table 201 (FIG. 2) (ST 1409). In this case, when the content shares some subroutines with existing content 107, the sharing relation may be registered dynamically as a library (registered in subroutine sharing table 243).

When data of the existing content 107 is downloaded (when judgment of ST 1408 is “N”) or after ST 1409, the subroutine management circuit 171 constituting the subroutine management part updates the subroutine management table 203 on the basis of information concerning each subroutine of the downloaded content 1303 (ST 1410).

When the subroutine management table 203 is updated, the following values are stored in respective items.
(1) content ID column 215: content ID assigned by server is stored therein
(2) subroutine ID column 217: subroutine ID assigned by server is stored therein
(3) JIT flag column 219: “no” is set thereto
(4) cache column 223: “no” is set in state column and “0” is set in number-of-times column
(5) first code address column 225: top address of first code 119 is stored therein
(6) processing address column 227: “null (e.g. 1”) is stored therein

Next, the client subroutine list 1305 is updated (ST 1411) and the processing is ended. Concretely, the following values are stored in respective items of the client subroutine list 1305.
(1) server URL column: URL of content delivering server 1301 of download source is stored therein
(2) subroutine ID column: subroutine ID assigned by server is stored therein
(3) hash value column: hash value is stored therein on the basis of information of server subroutine list received from server
(4) server notification column: “yes” is set thereto when notified as duplicate subroutine in ST 1404 and “no” is set thereto in case of newly downloaded subroutine

According to the above configuration, when the content 107, 1303 is downloaded by the mobile device 101, identifier (in the embodiment, hash value) of each subroutine contained in the content 107, 1303 can be used to judge for each subroutine whether the content has been downloaded or not. Information concerning the subroutine which has been downloaded is notified to the content delivering server 1301 and the server specifies subroutine which is not duplicate (not transmitted) to transmit it, so that only necessary data can be downloaded to thereby reduce the communication amount upon downloading of content 107, 1303 greatly.

Moreover, in the mobile device 101, whether the duplicate information of subroutine is notified or not is managed by flag (server notification) in the client subroutine list 1305 and accordingly when response to the server subroutine list 1307 is transmitted from the content delivering server 1301 upon downloading of content, only the duplicate information which is not notified can be transmitted to thereby reduce the communication amount.

The content delivering server 1301 desirably manages duplicate information of subroutine transmitted from the mobile device 101 for each terminal such as mobile device 101. Consequently, upon subsequent downloading of content 107, 1303, only information which is not transmitted in the server subroutine list 1307 concerning the content may be transmitted to the mobile device 101, so that the communication amount can be reduced.

The foregoing has described the embodiments of the present invention, although a realizable embodiment is not limited thereto. Modification examples of the embodiments of the present invention are described below.

### [Example of Information Processing Apparatus]

In the embodiments, the present invention is applied to the mobile device, although the present invention can be applied to various information processing apparatuses. Particularly, when the present invention is applied to so-called built-in apparatuses in which ability of various mountable devices is strictly restricted such as processing speed of CPU, memory capacity and picture display ability as compared with personal computers, the effects of the present invention can be enhanced remarkably. The built-in apparatuses contain, for example, personal devices such as portable information terminal such as personal digital assistants (PDA) and portable game machines, mobile devices, car navigation devices, home telephones, home game machines, television receivers and HDD (hard disk drive) recorders and business apparatuses such as karaoke apparatuses, robots, transport apparatuses for railroad, rockets and plant controllers. Among them, the built-in devices manufactured for portable use have large problem for restriction of resources and accordingly it is particularly desired to apply the present invention to the built-in devices.

### [Configuration Using No Cache Memory]

In the embodiment, the subroutine management table 205 is provided in the cache memory 177 and judgment of subroutine format and retrieval of priority are performed in the cache, although the configuration having no cache memory 117 is possible. In this case, the subroutine management table 203 in the memory 117 may be used to perform a variety of processing described above instead of the processing performed using the subroutine management table cache 205.

### [Judgement as to Whether Precompile is Performed]

In the embodiment, the state of compile concerning each entry is judged using the JIT flag, although it may be performed as follows: For example, when the first code 119 is precompiled into the second code 121 and when the second code 121 is compiled into the native code 131, its changed contents are detected to calculate hash values thereof so that the hash values are managed in two columns provided separately in the subroutine management table cache 205. Consequently, judgment as to the compile state (kind of code of subroutine) can be made on the basis of whether there is the hash value concerning precompile and whether there is the hash value concerning compile instead of kind of JIT flag.

### [Method of JIT Compile]

In the embodiment, the JIT compiler 159 of the virtual machine 129 merely converts subroutine (second code 121) to be executed into native code 131, although the following processing can be performed. That is, the JIT compiler 159 can inline expand second code 121 of precompile result of first code 119 into second code 121 of subroutine of reference source and convert it into native code 131 when there is another subroutine referred to in execution process of subroutine to be executed.

### [Precompile Method]

In the embodiment, the method of inline expanding first code of another subroutine referred to in execution process of subroutine into first code of subroutine of reference source has been described as the precompile method, although this processing can be controlled more minutely. For example, file capacity of each subroutine can be managed by the subroutine management table 203 or the subroutine management table cache 205 or described in predetermined place (e.g. header) of first code 119, so that only first code having capacity smaller than predetermined threshold can be inline expanded.

### [Connecting Method to Processor 113]

In the embodiment, the variety of hardware 105 are connected through bus 103 by way of example, although direct connecting can be made between the variety of hardware 105 such as between peripheral function unit 111 and processor 113 and between subroutine management circuit 171 and processor 113. Particularly, subroutine management table cache 205 of subroutine management circuit 171 is referred to by processor 113 each time subroutine is called up and accordingly when the subroutine management circuit 171 is directly coupled with the processor 113, improvement of access speed and reduction of load on bus 103 can be attained.

### [Configuration of First Code Processing Unit 123]

In the embodiment, the first code processing unit 123 includes subroutine management circuit 171, precompile circuit 173 and precompile control circuit 175 provided separately, although it is not limited thereto. These three circuits may be combined voluntarily to form a single circuit or two circuits.

### [Priority]

As modification examples of the priority, the following values can be adopted.
(1) value obtained by subtracting the number of stack frames of memory 117 at the time that each subroutine is called up during execution of content 107 from predetermined value
(2) the number of corresponding contents 107 for each subroutine
(3) value determined in accordance with processing contents of each subroutine

When the value of the above item (1) is adopted, the number of stack frames concerning each subroutine may be constructed to be written in the subroutine management table 203 or the subroutine management table cache 205 by the subroutine management circuit 171 constituting the subroutine management part. Furthermore, the predetermined value may be adjusted so that the operation speed of the precompile circuit 173 is proper on the basis of the operation speed defined in the operation speed definition table 301 in the embodiment. Alternatively, on the contrary, the operation speed in the operation speed definition table 301 may be adjusted on the basis of the priority calculated on the basis of predetermined value. In any case, the precompile control circuit 175 can use the priority written in the subroutine management table 203 or the subroutine management table cache 205 to judge operation speed from the operation speed definition table 301 and operate the precompile circuit 173 at the operation speed.

In this modification example, for example, when a plurality of subroutines are nested, the stack frame for subroutine referred to last is stacked on the stack frames of unprocessed plural subroutines and accordingly the number of stack frames is increased, so that when the increased number is subtracted from the predetermined value, a small value is obtained as a result. On the contrary, the number of stack frames for the subroutine referred to frequently (called up at early stage) is small and when the number is subtracted from the predetermined value, a large value is obtained as a result. Accordingly, the priority of subroutine which is frequently referred to and which is required to make precompile fast is heightened and the priority of subroutine which is not much referred to and is not required to make precompile in a hurry is lowered. Consequently, when the subroutine having low priority for precompile is precompiled, the operation speed of the precompile circuit 175 can be reduced to thereby reduce the power consumption.

When the value of the above item (2) is adopted, the subroutine sharing table 243 (FIG. 2) representing the correspondence relation of the subroutine and plural contents 107 is stored, as a minimum, in any of the memory 117 and the cache memory 177 when there is provided the cache memory 177. When the subroutine management circuit 171 executes a plurality of contents 107 simultaneously, subroutine is called up during execution of any content 107, although when there is first code 119 of subroutine waiting for processing, the subroutine management circuit 171 may perform control so that the precompile circuit 173 produces second code from first code on the basis of the subroutine sharing table 243 in order from subroutine having corresponding contents 107 increased in number out of subroutines.

When the value of the above item (3) is adopted, attribute information representing the contents of processing is previously described in the first code 119 of subroutine. Furthermore, an attribute management table in which priority order used to produce second code 121 from first code 119 is defined for each attribute information is stored in the memory 117. Subroutine is called up during execution of content, although when there is subroutine waiting for precompile (JIT flag is “req”), the subroutine management circuit 171 can perform execution control so that the subroutine management circuit 171 specifies priority order from the attribute management table using attribute information described in first code 119 of subroutines and produces second code 121 from first code 119 in accordance with the priority order.

Even other processing described using priority in the embodiments can be performed using the values described in the above items (1) to (3).

### [JIT Flag]

In the embodiment, when JIT flag is “pre”, existing second code is executed by JIT compiler 159, although as shown in FIG. 2 when size of first code 119 of each subroutine is managed by the first code size management table 239 of subroutine management table 203, the following processing may be performed. For example, size of first code 119 which is a source of second code 121 to be processed by JIT compiler 159 is judged from the first code size management table 239 and when the size of first code 119 is larger than predetermined threshold, any of the following processing is performed.
(1) First code 119 is executed by interpreter 157 and at the same time second code 121 is converted into native code 131 by JIT compiler 159 using another thread to be stored in memory 117.
(2) First code 119 is executed by interpreter 157.

When the size of code is larger, there is the merit of improving execution speed of content when the first code 119 is successively executed by the interpreter 157 as described above instead of waiting for execution until JIT compile is completed.

### [Kind of Content]

In the embodiment, Java program is adopted as content to be executed, although part or all of content to be adopted may be program (script) described in script language such as JS (JavaScript), PHP (Hypertext Preprocessor), Perl (Practical Extraction and Report Language), ActionScript or VBScript (Visual Basic Script). Accordingly, HTML file containing script partially can be treated. When the program is adopted, the second code can be produced by method of treating source code as first code and inline expanding first code of subroutine of called destination into first code of calling source as described above, for example. Furthermore, the code execution part 153 for executing each script may be structured by software. In this case, when program corresponding to so-called server-side script is adopted, the function for executing the server-side script by client terminal may be provided in reproduction application 125 or separately therefrom. Alternatively, the function of Web may be provided in the code execution part 153.

When HTML file is treated as first code 119, the subroutine management circuit 171 may be configured to be able to identify area enclosed by specific tag as subroutine and calculate hash value for each identified subroutine. Consequently, for example, when the mobile device 101 downloads HTML file as content 107, changed (non-duplicate) subroutine can be specified on the basis of the hash value and only the changed part can be downloaded. Adoption of this method can perform acquisition processing of difference data at high speed. As a built-in system utilizing such processing, for example, there is considered a Web patrol robot configured to get data of predetermined Web site periodically.

### [Cache Update Processing]

In the embodiment, one entry having cache out count equal to 0 or minimum is detected with reference to entries in the subroutine management table cache 205 in order from the top position thereof and is rewritten with entry of corresponding subroutine in the subroutine management table 203, although the following algorithm may be adopted. That is, as the method of writing back entry in the subroutine management table 203, there are a method of searching the subroutine management table cache 205 to write back all entries having cache out count equal to 0 and a method of preferentially writing back entries corresponding to subroutine which is not executed for a fixed time from starting. As a method of storing entry in subroutine management table cache 205, there is a method of preparing a calling relation table for specifying another subroutine referred to from each subroutine and storing entries of called-up subroutine and another subroutine referred to from the subroutine on the basis of the table.

### [Subroutine Definition Value]

In the embodiment, the method of embedding subroutine definition value in first code using compiler upon production of first code has been described, although the present invention is not limited thereto. For example, a programmer himself may write subroutine definition value in source code. Alternatively, program of judging the number of different subroutines called up by first code of a certain subroutine and the frequency with which the different subroutines are called up by first code of the certain subroutine and the number of times of called operations of the subroutine called up from different subroutines and the frequency with which the subroutine is called up from different subroutines and giving subroutine definition value thereto is prepared and subroutine definition value is written in first code of subroutine using the program. The program may give subroutine definition value on the basis of time required to convert first code of subroutine into second code.

### [Order of Precompile]

In the embodiment, when there are a plurality of first codes 119 to be precompiled, that is, when there are a plurality of entries of subroutine having JIT flag of “req” in processing waiting state, the first codes are precompiled in order from subroutine having higher priority, although the present invention is not limited thereto. Precompile may be performed by any of the following methods, for example.
(1) Subroutine has been called up during execution of content 107, although when first code 119 of subroutine called up before it is not converted into second code 121 (when there is entry having JIT flag of “req”), the precompile circuit 173 can convert first code 119 of subroutine called up finally of the subroutines into second code 121 in order from the subroutine called up finally.
(2) There is provided a display for displaying an indication corresponding to content 107. Subroutine has been called up during execution of content 107, although when second code 121 is not produced from first code 119 of subroutine called up before it (when there is subroutine waiting for precompile), the subroutine management circuit 171 can perform execution control so that second code 121 is produced preferentially from first code 119 of subroutine contained in content corresponding to indication displayed in center or in front of the display or largest indication displayed on the display.
(3) There is further provided an operation part for moving an indicator such as arrow displayed in display and selecting indication by the indicator. Subroutine has been called up during execution of content 107, although when there is subroutine waiting for precompile, the subroutine management circuit 171 can perform execution control so that second code 121 is produced preferentially from first code of subroutine contained in content 107 corresponding to the indication overlapping the indicator or the indication selected by the indicator in the display.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus comprising:
a memory to store therein a subroutine management table which manages kinds of existing codes out of a native code executable by a processor, a first code which is a source of the native code and does not depend on an operating system and a second code produced in process of converting the first code into the native code for a plurality of subroutine contained in a content;
a virtual machine having an interpreter function to execute the first code by an interpreter method and a JIT (Just-In-Time) compile function to convert the second code into the native code to be executed;
a precompile circuit to produce the second code from the first code; and
subroutine management means to perform execution control so that as a result of referring to the subroutine management table for the subroutine called up during execution of the content, when there is the native code, the native code is executed by the processor and when there is the second code, the second code is executed by the JIT compile function of the virtual machine and the produced native code is stored in the memory or when there is the first code, the first code is executed by the interpreter function of the virtual machine and is converted into the second code by the precompile circuit to store the second code in the memory, the subroutine management means performing recording control so that when the kind of code referred to when the subroutine is executed by the execution control is changed, the changed kind is recorded in the subroutine management table.

2. An information processing apparatus according to claim 1, wherein
the subroutine management means performs the execution control so that the first code is converted into the second code in order from subroutine having higher priority for conversion of the first code into the second code and defined on the basis of a predetermined standard for each subroutine.

3. An information processing apparatus according to claim 2, wherein
the memory stores therein an operation speed definition table in which operation speed of the precompile circuit is defined in accordance with the priority and
the information processing apparatus further comprises
precompile control means which controls to judge the operation speed from the operation speed definition table on the basis of the priority of the subroutine corresponding to the first code processed by the precompile circuit and operate the precompile circuit in accordance with the operation speed.

4. An information processing apparatus according to claim 2, wherein
the priority is the number of times of called operations of each subroutine called up during execution of the content or a value obtained by subtracting the number of stack frames at the time that each subroutine is called up during execution of the content from a predetermined value.

5. An information processing apparatus according to claim 2, wherein
the priority is a value previously described in the first code of each subroutine on the basis of time required to convert the first code of each subroutine contained in the content into the second code or frequency with which each subroutine is called up during execution of the content.

6. An information processing apparatus according to claim 3, wherein
the precompile control means reduces a supply voltage to the precompile circuit within a range of voltage by which operation of the precompile circuit can be maintained when the operation speed of the precompile circuit is reduced.

7. An information processing apparatus according to claim 2, wherein
the precompile control means monitors a data transmission amount within a bus or access frequency to the memory by the processor and stops operation of the precompile circuit while the data transmission amount or the access frequency exceeds a predetermined reference.

8. An information processing apparatus according to claim 1, further comprising
a cache memory in which contents of the subroutine management table are stored as a subroutine management table cache and
wherein
the subroutine management means performs the execution control and the recording control on the basis of the subroutine management table cache instead of the subroutine management table and performs cache control so that transfer and rewriting of data are performed between the subroutine management table and the subroutine management table cache at predetermined timing.

9. An information processing apparatus according to claim 8, wherein
the subroutine management means performs the cache control so that
when the content is started to be executed, information of the subroutine contained in the content to be executed is written from the subroutine management table into the subroutine management table cache in order of higher priority and
when information of the called-up subroutine does not exist in the subroutine management table cache during execution of the content, information of the subroutine having lowest priority in the subroutine management table cache is written back into the subroutine management table and information of the called-up subroutine is written from the subroutine management table into the subroutine management table cache.

10. An information processing apparatus according to claim 1, wherein
the first code is a code for stack machine and
the second code contains a code for register machine produced from the first code.

11. An information processing apparatus according to claim 1, wherein
the second code contains a code formed by inline expanding the first code of another subroutine called up in execution process of the subroutine into a first code of the subroutine of a calling source.

12. An information processing apparatus according to claim 1, wherein
the memory stores therein a correction dictionary in which a correction method of unnecessary description, grammatical defect or error in writing in the first code is defined and
the second code contains a code formed by optimizing the first code on the basis of the correction dictionary.

13. An information processing apparatus according to claim 1, wherein
the JIT compile function inline expands the second code of precompile result of the first code of another subroutine called up in execution process of the second code into the second code of a calling source and converts it into the native code.

14. An information processing apparatus according to claim 2, wherein
the memory stores therein a subroutine sharing table representing correspondence relation to a plurality of contents for each subroutine and
the subroutine management means performs the execution control so that the first code is converted into the second code in order from subroutine having corresponding contents increased in number on the basis of the subroutine sharing table instead of the priority.

15. An information processing apparatus according to claim 2, wherein
the subroutine management means performs the execution control so that the first code is converted into the second code in order from subroutine called up finally of subroutines called up during execution of the content instead of the priority.

16. An information processing apparatus according to claim 2, wherein
the first code includes attribute information described previously therein for representing contents of processing for corresponding subroutine and
the memory stores therein an attribute management table in which priority order for producing the second code from the first code for each attribute information is defined,
the subroutine management means performing the execution control so that the priority order is specified from the attribute management table by means of attribute information described in the first code of subroutine called up during execution of the content and the first code is converted into the second code in accordance with the priority order instead of the priority.

17. An information processing apparatus according to claim 2, further comprising
a display to display an indication corresponding to the content and
wherein
the subroutine management means performs the execution control so that the second code is produced preferentially from the first code of subroutine contained in the content corresponding to the indication displayed in center or in front of the display or a largest indication displayed on the display instead of the priority.

18. An information processing apparatus according to claim 17, further comprising
an operation part to move an indicator containing arrow displayed on the display and select the indication by the indicator and
wherein
the subroutine management means performs the execution control so that the second code is produced preferentially from the first code of subroutine contained in the content corresponding to the indication overlapping the indicator or the indication selected by the indicator on the display.

19. An information processing apparatus according to any of claims 1 to 18, wherein
part or all of the contents are script or Java program.
